(19) United States
(12) Patent Application Publication
(10) Pub. No.: US 2020/0241172 A1
(43) Pub. Date: Jul. 30, 2020

(54) ANTIREFLECTIVE FILM, METHOD FOR MANUFACTURING ANTIREFLECTIVE FILM, MOLD, AND METHOD FOR MANUFACTURING MOLD

(71) Applicant: Sharp Kabushiki Kaisha, Sakai City, Osaka (JP)

(72) Inventors: Hidekazu HAYASHI, Sakai City (JP); Tokio TAGUCHI, Sakai City (JP); Yukio SHIMAMURA, Osaka-shi (JP); Tomoyuki KITAGAWA, Osaka-shi (JP)

(21) Appl. No.: 16/483,100

(22) PCT Filed: Feb. 1, 2018
(86) PCT No.: PCT/JP2018/003480

§ 371 Date: Aug. 2, 2019

(30) Foreign Application Priority Data
Feb. 3, 2017 (JP) 2017-018555

(51) Int. Cl. G02B 1/11; C25D 11/04; B29C 33/42

(52) U.S. Cl. CPC G02B 1/11; C25D 11/04; B29L 2011/00; B29K 2905/02; B29C 33/424

(57) ABSTRACT

A manufacturing method of a mold (100) includes the steps of: (a) providing a mechanically mirror-finished aluminum base (12); (b) propelling an abrasive media toward a surface of the aluminum base, thereby forming a plurality of recessed portions (12a) in the surface (12s) of the aluminum base, the abrasive media being generally-spherical, the abrasive media containing an alumina particle, an average particle diameter of the abrasive media being not less than 10 μm and not more than 40 μm; (c) after step (b), forming an inorganic material layer (16) over the surface of the aluminum base and forming an aluminum film (18) over the inorganic material layer, thereby forming a mold base (10); and after step (c), anodizing a surface of the aluminum film and bringing the porous alumina layer into contact with an etchant.

### TECHNICAL FIELD

The present invention relates to an antireflection film, a production method of an antireflection film, a mold, and a manufacturing method of a mold. In this specification, the “mold” includes molds that are for use in various processing methods (stamping and casting), and is also referred to as a stamper. The mold can also be used for printing (including nanoimprinting).

### BACKGROUND ART

Display devices for use in TVs, cell phones, etc., and optical elements, such as camera lenses, etc., usually adopt an antireflection technique in order to reduce the surface reflection and increase the amount of light transmitted therethrough. This is because, when light is transmitted through the interface between media of different refractive indices, e.g., when light is incident on the interface between air and glass, the amount of transmitted light decreases due to, for example, Fresnel reflection, thus deteriorating the visibility.

An antireflection technique which has been receiving attention in recent years is forming over a substrate surface a microscopic uneven pattern in which the interval of recessed portions or raised portions is not more than the wavelength of visible light (A=380 nm to 780 nm). See Patent Documents Nos. 1 to 3. The two-dimensional size of a raised portion of an uneven pattern which performs an antireflection function is not less than 10 nm and less than 500 nm. Here, the “two-dimensional size” of the raised portions refers to the area equivalent circle diameter of the raised portions viewed in a direction normal to the surface. For example, when the raised portions have a conical shape, the two-dimensional size of the raised portions is equivalent to the diameter of the base of the cone. The same applies to the “two-dimensional size” of the recessed portions.

This method utilizes the principles of a so-called moth-eye structure. The refractive index for light that is incident on the substrate is continuously changed along the depth direction of the recessed portions or raised portions, from the refractive index of a medium on which the light is incident to the refractive index of the substrate, whereby reflection of a wavelength band that is subject to antireflection is prevented.

The moth-eye structure is advantageous in that it is capable of performing an antireflection function with small incident angle dependence over a wide wavelength band, as well as that it is applicable to a number of materials, and that an uneven pattern can be directly formed in a substrate. As such, a high-performance antireflection film (or antireflection surface) can be provided at a low cost.

As the method of forming a moth-eye structure, using an anodized porous alumina layer which is obtained by means of anodization of aluminum has been receiving attention (Patent Documents Nos. 2 and 3).

Utilizing an anodized porous aluminum film can facilitate the manufacture of a mold which is used for formation of a moth-eye structure over a surface (hereinafter, “moth-eye mold”). In particular, as described in Patent Documents Nos. 2 and 3, when the surface of the anodized aluminum film as formed is used as a mold without any modification, a large effect of reducing the manufacturing cost is achieved. The structure of the surface of a moth-eye mold which is capable of forming a moth-eye structure is herein referred to as “inverted moth-eye structure”.

As described in Patent Documents Nos. 1 to 5, by providing an uneven structure which is greater than a moth-eye structure in addition to the moth-eye structure, the antireflection film (or antireflection surface) can be provided with an antiglare function. The two-dimensional size of a raised portion or a recessed portion of the uneven structure which is capable of performing the antiglare function (also referred to as “antiglare structure”) is, for example, not less than 200 nm and less than 100 μm. The structure of the surface of a mold which is capable of forming the antiglare structure is referred to as “inverted antiglare structure”. The entire disclosures of Patent Documents Nos. 1 to 4 are incorporated by reference in this specification.

### CITATION LIST

### Patent Literature

Patent Document No. 1: Japanese PCT National Phase Laid-Open Publication No. 2001-517319
Patent Document No. 2: Japanese PCT National Phase Laid-Open Publication No. 2003-531962
Patent Document No. 3: WO 2006/059686
Patent Document No. 4: WO 2011/052652
Patent Document No. 5: WO 2013/099935

### SUMMARY OF INVENTION

### Technical Problem

Methods for efficiently manufacturing a mold for forming an antireflection film (or antireflection surface) which has a desired antiglare function have been studied. A trend in recent years is that clear images are favored. Specifically, the trend is that an antireflection film is demanded which is capable of exhibiting an antiglare property without deteriorating high-definition images, while providing clear images, when adhered to a high-definition display panel. The present applicant produced such an antireflection film and found that, when viewed at an oblique viewing angle, images seen through the antireflection film were disadvantageously whitish. Details will be described later.

The objects of the present invention include providing an antireflection film (or antireflection surface) which is capable of exhibiting an antiglare property while providing clear images and preventing itself from appearing whitish when viewed at an oblique viewing angle, providing a method for producing such an antireflection film, providing a mold for producing such an antireflection film, and providing a method for efficiently manufacturing such a mold.

### Solution to Problem

A mold manufacturing method according to an embodiment of the present invention includes the steps of: (a) providing a mechanically mirror-finished aluminum base; (b) propelling an abrasive media toward a surface of the aluminum base, thereby forming a plurality of first recessed portions at the surface of the aluminum base, the abrasive media being generally-spherical, the abrasive media containing an alumina particle, an average particle diameter of the abrasive media being not less than 10 μm and not more than 40 μm; (c) after step (b), forming an inorganic material layer over the surface of the aluminum base and forming an aluminum film over the inorganic material layer, thereby forming a mold base; (d) after step (c), anodizing a surface of the aluminum film, thereby forming a porous alumina layer which has a plurality of second recessed portions; (e) after step (d), bringing the porous alumina layer into contact with an etchant, thereby enlarging the plurality of second recessed portions of the porous alumina layer; and (f) after step (e), further performing anodization, thereby growing the plurality of second recessed portions.

In one embodiment, the average particle diameter of the abrasive media is not less than 10 μm and less than 35 μm.

In one embodiment, a granularity distribution of the abrasive media has a peak within a range of ±10% from the average particle diameter.

In one embodiment, the manufacturing method further includes the step of (g) between step (b) and step (c), performing electrolytic polishing on the surface of the aluminum base.

A mold according to an embodiment of the present invention is a mold manufactured by the mold manufacturing method as set forth in any of the foregoing paragraphs.

A mold according to another embodiment of the present invention is a mold having a surface structure, the surface structure having a plurality of first recessed portions whose two-dimensional size as viewed in a normal direction of the surface is not less than 1 μm and not more than 12 μm and a plurality of second recessed portions whose two-dimensional size as viewed in a normal direction of the surface is not less than 10 nm and less than 500 nm, wherein an adjoining distance of the plurality of first recessed portions is not less than 2 μm and not more than 10 μm.

An antireflection film production method according to an embodiment of the present invention includes the steps of: providing the mold as set forth in any of the foregoing paragraphs; providing a work; irradiating a photocurable resin applied between the mold and a surface of the work with light, thereby curing the photocurable resin; and separating the mold from an antireflection film that is formed of the cured photocurable resin.

An antireflection film according to an embodiment of the present invention is an antireflection film produced by the antireflection film production method as set forth in the foregoing paragraph.

An antireflection film according to another embodiment of the present invention has a surface structure, the surface structure having a plurality of first raised portions whose two-dimensional size as viewed in a normal direction of the surface is not less than 1 μm and not more than 12 μm and a plurality of second raised portions whose two-dimensional size as viewed in a normal direction of the surface is not less than 10 nm and less than 500 nm, wherein a specular gloss at 20° is not less than 0.01 and not more than 0.1 when a specular gloss at 60° is assumed to be 1.

In one embodiment, the specular gloss at 20° is not less than 0.01 and not more than 1.0, and the specular gloss at 60° is not less than 1.0 and not more than 10.0.

In one embodiment, the specular gloss at 20° is not less than 0.001 and not more than 0.005 when a specular gloss at 85° is assumed to be 1.

In one embodiment, the specular gloss at 85° is not less than 50.0 and not more than 75.0.

In one embodiment, a light distribution curve for an incident angle of 5° in a graph where a horizontal axis represents a light receiving angle and a vertical axis represents a common logarithm of a relative diffuse reflectance (%) which is normalized with a maximum of a diffuse reflected light intensity being 80% is characterized in that the relative diffuse reflectance (%) is not less than 3% when the light receiving angle is in a range of not less than 5° and not more than 7°, the light distribution curve includes a point at which the light receiving angle is in a range of not less than 8° and not more than 10° and the relative diffuse reflectance (%) is in a range of not less than 2% and not more than 8%, and the light distribution curve includes a point at which the light receiving angle is in a range of not less than 10° and not more than 15° and the relative diffuse reflectance (%) is in a range of not less than 0.9% and not more than 1.1%.

In one embodiment, a haze value is not less than 2% and not more than 40%.

An antireflection film production method according to another embodiment of the present invention includes the steps of: manufacturing a mold by a mold manufacturing method which includes the steps of (a) providing a mechanically mirror-finished aluminum base, (b) propelling an abrasive media toward a surface of the aluminum base, thereby forming a plurality of first recessed portions at the surface of the aluminum base, the abrasive media being generally-spherical, the abrasive media containing an alumina particle, an average particle diameter of the abrasive media being not less than 10 μm and not more than 40 μm, (c) after step (b), forming an inorganic material layer over the surface of the aluminum base and forming an aluminum film over the inorganic material layer, thereby forming a mold base, (d) after step (c), anodizing a surface of the aluminum film, thereby forming a porous alumina layer which has a plurality of second recessed portions, (e) after step (d), bringing the porous alumina layer into contact with an etchant, thereby enlarging the plurality of second recessed portions of the porous alumina layer, and (f) after step (e), further performing anodization, thereby growing the plurality of second recessed portions; providing a work; irradiating a photocurable resin applied between the mold and a surface of the work with light, thereby curing the photocurable resin; and separating the mold from an antireflection film formed of the cured photocurable resin, wherein the antireflection film having a surface structure, the surface structure having a plurality of first raised portions whose two-dimensional size as viewed in a normal direction of the surface is not less than 1 μm and not more than 5 μm and a plurality of second raised portions whose two-dimensional size as viewed in a normal direction of the surface is not less than 10 nm and less than 500 nm, and a specular gloss at 20° is not less than 0.01 and not more than 0.1 when a specular gloss at 60° is assumed to be 1.

An antireflection film production method according to still another embodiment of the present invention includes the steps of: manufacturing a mold by a mold manufacturing method which includes the steps of (a) providing a mechanically mirror-finished aluminum base, (b) propelling an abrasive media toward a surface of the aluminum base, thereby forming a plurality of first recessed portions at the surface of the aluminum base, the abrasive media being generally-spherical, the abrasive media containing an alumina particle, an average particle diameter of the abrasive media being not less than 10 μm and not more than 40 μm, (c) after step (b), forming an inorganic material layer over the surface of the aluminum base and forming an aluminum film over the inorganic material layer, thereby forming a mold base, (d) after step (c), anodizing a surface of the aluminum film, thereby forming a porous alumina layer which has a plurality of second recessed portions, (e) after step (d), bringing the porous alumina layer into contact with an etchant, thereby enlarging the plurality of second recessed portions of the porous alumina layer, and (f) after step (e), further performing anodization, thereby growing the plurality of second recessed portions; providing a work; irradiating a photocurable resin applied between the mold and a surface of the work with light, thereby curing the photocurable resin; and separating the mold from an antireflection film formed of the cured photocurable resin, wherein the antireflection film having a surface structure, the surface structure having a plurality of first raised portions whose two-dimensional size as viewed in a normal direction of the surface is not less than 1 μm and not more than 5 μm and a plurality of second raised portions whose two-dimensional size as viewed in a normal direction of the surface is not less than 10 nm and less than 500 nm, and a specular gloss at 20° is not less than 0.001 and not more than 0.005 when a specular gloss at 85° is assumed to be 1.

### Advantageous Effects of Invention

According to an embodiment of the present invention, an antireflection film (or antireflection surface) which is capable of exhibiting an antiglare property while providing clear images and preventing itself from appearing whitish when viewed at an oblique viewing angle, a method for producing such an antireflection film, a mold for producing such an antireflection film, and a method for efficiently manufacturing such a mold are provided.

### BRIEF DESCRIPTION OF DRAWINGS

FIG. 1(a) to FIG. 1(d) are schematic cross-sectional views for illustrating a manufacturing method of a moth-eye mold 100 of an embodiment of the present invention.

FIG. 2 is a schematic diagram for illustrating the step of forming an inverted antiglare structure by propelling an abrasive media toward the surface of an aluminum base 12 in the manufacturing process of a moth-eye mold 100 of an embodiment of the present invention.

FIG. 3 is a diagram for illustrating a production method of an antireflection film with the use of the moth-eye mold 100.

FIG. 4(a) and FIG. 4(b) are SEM images of the surfaces of small aluminum pieces each having an inverted antiglare structure formed by propelling an abrasive media (the full scale in the SEM images is 20.0 μm).

FIG. 5(a) and FIG. 5(b) show optical images of a display panel with the antireflection film sheet of Example 1 (center), the antireflection film sheet of Reference Example 1 (right) and the antireflection film sheet of Comparative Example 1 (left) being adhered to the surface of the display panel. FIG. 5(a) shows an optical image viewed in the normal direction of the surface. FIG. 5(b) shows an optical image viewed at an oblique viewing angle (polar angle: 60°).

FIG. 6(a) to FIG. 6(c) are SEM images of an antireflection film of an embodiment of the present invention. FIG. 6(a) is a SEM image of the surface of the antireflection film as viewed in a vertical direction (the full scale in the SEM image is 10.0 μm). FIG. 6(b) is a cross-sectional SEM image of the antireflection film (the full scale in the SEM image is 3.0 μm). FIG. 6(c) is a cross-sectional SEM image of the antireflection film (the full scale in the SEM image is 500 nm).

FIG. 7(a) to FIG. 7(c) are SEM images of an antireflection film of a reference example. FIG. 7(a) is a SEM image of the surface of the antireflection film as viewed in a vertical direction (the full scale in the SEM image is 10.0 μm). FIG. 7(b) is a cross-sectional SEM image of the antireflection film (the full scale in the SEM image is 3.0 μm). FIG. 7(c) is a cross-sectional SEM image of the antireflection film (the full scale in the SEM image is 500 nm).

FIG. 8(a) and FIG. 8(b) are schematic cross-sectional views of antireflection film sheets which have an antiglare function. FIG. 8(a) is a schematic cross-sectional view of the antireflection film sheet 50 which has an antiglare structure at its surface. FIG. 8(b) is a schematic cross-sectional view of the antireflection film sheet 950 which has an antiglare function layer at a level more internal than the surface.

FIG. 9(a) shows the photopic contrast ratio of the antireflection film sheets of Comparative Example 2 to Comparative Example 7 and Comparative Example 10 as viewed from the front direction. FIG. 9(b) shows the luminance in the white display state of the antireflection film sheets of Comparative Example 2 to Comparative Example 7 and Comparative Example 10 as viewed from the front direction. FIG. 9(c) shows the luminance in the black display state of the antireflection film sheets of Comparative Example 2 to Comparative Example 7 and Comparative Example 10 as viewed from the front direction.

FIG. 10(a) is a graph showing the measurement results of the light distribution of diffuse reflected light from the antireflection film sheets of Comparative Example 3 to Comparative Example 7. FIG. 10(b) is a schematic diagram showing the system for measuring the light distribution of the diffuse reflected light.

FIG. 11(a) and FIG. 11(b) are graphs showing the measurement results of the luminance in the white display state of the antireflection film sheets of Comparative Example 2 to Comparative Example 7, which was measured with varying polar angles. FIG. 11(b) shows an enlarged part of the graph of FIG. 11(a).

FIG. 12(a) and FIG. 12(b) are diagrams showing the relationship in size between the uneven structure for formation of the antiglare structure and the dot pitch Px in the row direction.

FIG. 13 is a graph showing the measurement results of the light distribution of diffuse reflected light from the antireflection film sheets of Example 3, Reference Example 2, Comparative Example 3, Comparative Example 5, Comparative Example 12 and Comparative Example 13.

### DESCRIPTION OF EMBODIMENTS

Hereinafter, an antireflection film, a production method of an antireflection film, a mold for production of an antireflection film, and a manufacturing method of a mold according to embodiments of the present invention are described with reference to the drawings. The present invention is not limited to the embodiments illustrated below. In the drawings mentioned below, components which have substantially the same functions are designated with common reference numerals, and the descriptions thereof are sometimes omitted.

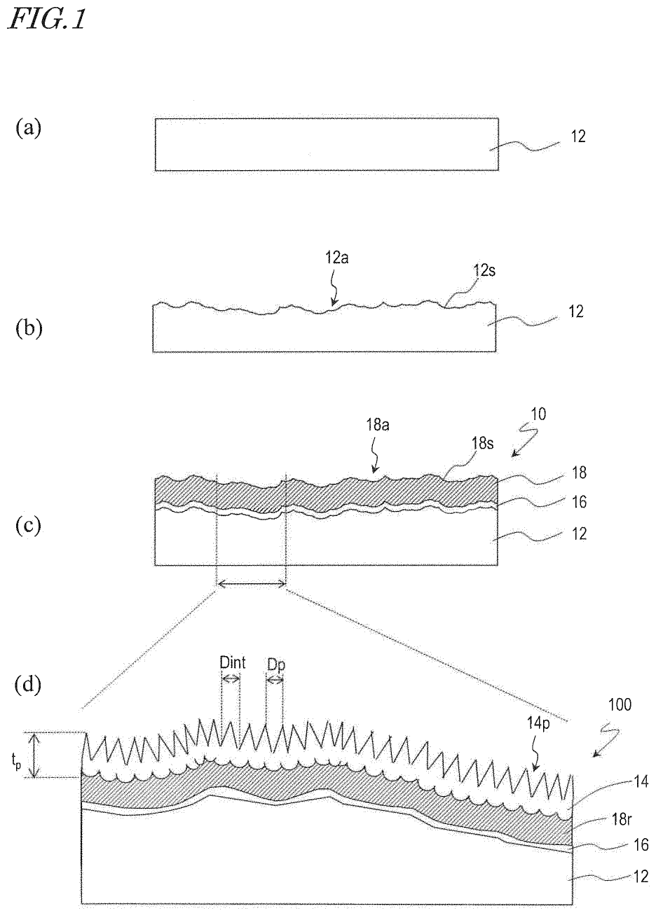

A manufacturing method of a mold according to an embodiment of the present invention is described with reference to FIG. 1 and FIG. 2.

First, refer to FIG. 1. FIG. 1(a) to FIG. 1(d) are schematic cross-sectional views for illustrating a manufacturing method of a moth-eye mold 100 according to an embodiment of the present invention. FIG. 1(a) is a schematic cross-sectional view of an aluminum base 12. FIG. 1(b) is a cross-sectional view schematically showing the surface structure of the aluminum base 12 which has an inverted antiglare structure. FIG. 1(c) is a schematic cross-sectional view of a mold base 10 obtained by forming an inorganic material layer 16 and an aluminum film 18 over the surface of the aluminum base 12. FIG. 1(d) is a schematic cross-sectional view of the moth-eye mold 100 which has an inverted antiglare structure and an inverted moth-eye structure superposed over the inverted antiglare structure. FIG. 1(d) corresponds to a part of FIG. 1(c) (a region between broken lines).

In this specification, the mold base refers to an object of the anodization and the etching in the mold manufacturing process. The aluminum base refers to aluminum in bulk which is self-supporting.

Although FIG. 1 enlargedly shows part of the moth-eye mold 100, the moth-eye mold 100 of an embodiment of the present invention has, for example, the shape of a hollow cylinder (roll). As disclosed in WO 2011/105206, when a moth-eye mold in the shape of a hollow cylinder is used, the antireflection film can be efficiently produced according to a roll-to-roll method. The entire disclosure of WO 2011/105206 is incorporated by reference in this specification. The following description is presented with an example of a mold in the shape of a hollow cylinder, although a mold according to an embodiment of the present invention is not limited to the shape of a hollow cylinder.

First, as shown in FIG. 1(a), a base 12 in the shape of a hollow cylinder is provided. The base 12 in the shape of a hollow cylinder is made of, for example, aluminum. Hereinafter, an example of the aluminum base 12 is described. The aluminum base 12 is mechanically mirror-finished. The aluminum base 12 in the shape of a hollow cylinder is made of, for example, an Al—Mg—Si based aluminum alloy.

The aluminum base 12 used may be an aluminum base whose aluminum purity is not less than 99.50 mass % and less than 99.99 mass % and which has relatively high rigidity. The impurity contained in the aluminum base 12 may preferably include at least one element selected from the group consisting of iron (Fe), silicon (Si), copper (Cu), manganese (Mn), zinc (Zn), nickel (Ni), titanium (Ti), lead (Pb), tin (Sn) and magnesium (Mg). Particularly, Mg is preferred. Since the mechanism of formation of pits (hollows) in the etching step is a local cell reaction, the aluminum base 12 ideally does not contain any element which is nobler than aluminum. It is preferred that the aluminum base 12 used contains, as the impurity element, Mg (standard electrode potential: −2.36 V) which is a base metal. If the content of an element nobler than aluminum is 10 ppm or less, it can be said in terms of electrochemistry that the aluminum base 12 does not substantially contain the element. The Mg content is preferably 0.1 mass % or more of the whole. It is, more preferably, in the range of not more than about 3.0 mass %. If the Mg content is less than 0.1 mass %, sufficient rigidity cannot be obtained. On the other hand, as the Mg content increases, segregation of Mg is more likely to occur. Even if the segregation occurs near a surface over which a moth-eye mold is to be formed, it would not be detrimental in terms of electrochemistry but would be a cause of a defect because Mg forms an anodized film of a different form from that of aluminum. The content of the impurity element may be appropriately determined depending on the shape, thickness, and size of the aluminum base 12, in view of required rigidity. For example, when the aluminum base 12 in the form of a plate is prepared by rolling, the appropriate Mg content is about 3.0 mass %. When the aluminum base 12 having a three-dimensional structure of, for example, a hollow cylinder is prepared by extrusion, the Mg content is preferably 2.0 mass % or less. If the Mg content exceeds 2.0 mass %, the extrudability deteriorates in general.

The mechanical mirror-finishing is, preferably, bit cutting. If, for example, abrasive particles are remaining on the surface of the aluminum base 12, conduction will readily occur between the aluminum film 18 and the aluminum base 12 in a portion in which the abrasive particles are present. Not only in the portion in which the abrasive particles are remaining but also in a portion which has a roughened surface, conduction is likely to occur locally between the aluminum film 18 and the aluminum base 12. When conduction occurs locally between the aluminum film 18 and the aluminum base 12, there is a probability that a local cell reaction will occur between an impurity in the aluminum base 12 and the aluminum film 18.

The aluminum base 12 in the shape of a hollow cylinder is typically formed by hot extrusion. The hot extrusion includes mandrel extrusion and porthole extrusion. The aluminum base 12 used is preferably formed by mandrel extrusion. If formed by porthole extrusion, the aluminum base 12 in the shape of a hollow cylinder has a seam (weld line) in the outer perimeter surface. The seam is reflected in the moth-eye mold 100. Therefore, at some degrees of precision required of the moth-eye mold 100, the aluminum base 12 used is preferably formed by mandrel extrusion.

Note that the problem of the seam can be solved by performing cold drawing on the aluminum base 12 formed by porthole extrusion. As a matter of course, cold drawing may also be performed on the aluminum base 12 formed by mandrel extrusion.

Then, by propelling an abrasive media toward the surface of the aluminum base 12, an inverted antiglare structure is formed at the surface 12s of the aluminum base 12 as shown in FIG. 1(b). The inverted antiglare structure formed by propelling the abrasive media has a plurality of first recessed portions 12a.

Now, the method for forming an inverted antiglare structure at the surface 12s of the aluminum base 12 is described with reference to FIG. 2. FIG. 2 is a schematic diagram for illustrating the step of forming an inverted antiglare structure by propelling an abrasive media toward the surface of the aluminum base 12 (also referred to as “blasting treatment step”) in the manufacturing process of the moth-eye mold 100 of an embodiment of the present invention.

First, the aluminum base 12 shown in FIG. 1(a) is provided. An aluminum base in the shape of a hollow cylinder is arranged in an upright position such that the long axis direction is generally parallel to the vertical direction.

Then, an abrasive media is propelled from the nozzle 82 against the aluminum base 12, whereby an inverted antiglare structure is formed at the surface of the aluminum base 12. The abrasive media is generally spherical. The abrasive media contains alumina particles. The average particle diameter of the abrasive media is not less than 10 μm and not more than 40 μm.

By changing the conditions for propelling of the abrasive media in addition to the conditions of the abrasive media, the shape of the inverted antiglare structure formed at the surface of the aluminum base 12 can be changed. For example, in the step of propelling the abrasive media, the aluminum base 12 may be rotated about the long axis of the aluminum base 12. Thereby, the abrasive media can be evenly propelled toward the surface of the aluminum base 12 (the lateral surface of the aluminum base 12 in the shape of a hollow cylinder), and the inverted antiglare structure can be evenly formed at the surface of the aluminum base 12. In FIG. 2, vᵣ is the velocity of rotation of the aluminum base 12 about the long axis of the aluminum base 12. For example, the nozzle 82 may be moved along the long axis direction of the aluminum base 12. In FIG. 2, vᵥ is the velocity of movement of the nozzle 82 along the long axis direction of the aluminum base 12.

The conditions for propelling of the abrasive media include, for example, the distance d between the nozzle 82 and the surface of the aluminum base 12, the ejection pressure of the abrasive media, and the velocity vᵥ of movement of the nozzle 82. The rotation velocity vᵣ of the aluminum base 12 and the duration of ejection of the abrasive media are appropriately adjusted according to the area to be treated (the area of a part of the surface of the aluminum base 12 on which the blasting treatment is to be performed).

In an embodiment of the present invention, the average particle diameter of the abrasive media may be not less than 10 μm and less than 35 μm. The particle size distribution of the abrasive media may have, for example, a peak within the range of ±10% from the average particle diameter.

The inverted antiglare structure formed by the blasting treatment will be described later with reference to experimental examples.

Then, as shown in FIG. 1(c), an inorganic material layer 16 is formed on the surface of the aluminum base 12, and an aluminum film 18 is formed on the inorganic material layer 16, whereby a mold base 10 is produced.

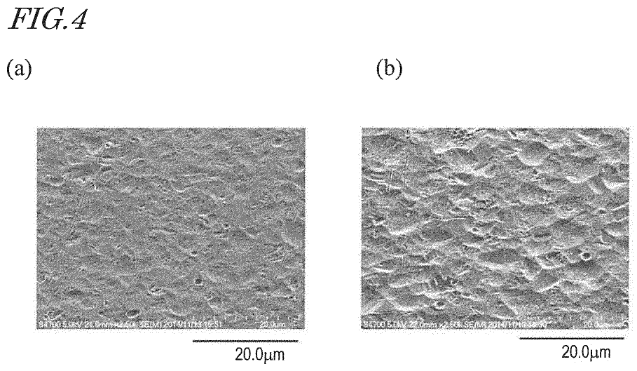

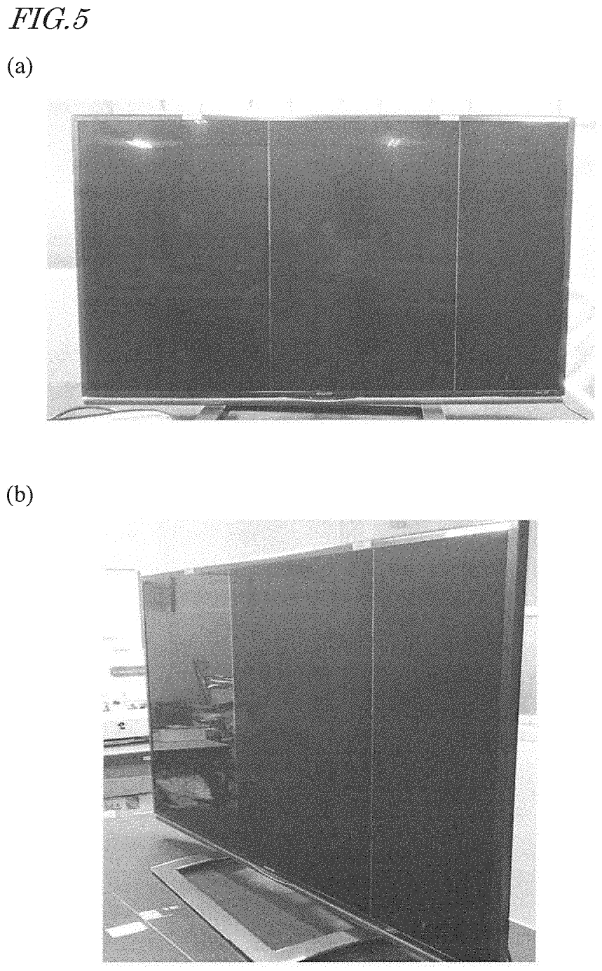

The surface of the aluminum film 18 has a structure in which an inverted antiglare structure formed by performing the blasting treatment on the surface of the aluminum base 12 is reflected. The inverted antiglare structure formed at the surface 18s of the aluminum film 18 is more moderate than the inverted antiglare structure formed at the surface 12s of the aluminum base 12. Herein, the structure formed in the aluminum film 18 is also referred to as “inverted antiglare structure”. The inverted antiglare structure formed at the surface of the aluminum film 18 has a plurality of third recessed portions 18a. Details of the plurality of third recessed portions 18a and the plurality of first recessed portions 12a will be described later with reference to FIG. 4.

The material of the inorganic material layer 16 may be, for example, tantalum oxide (Ta₂O₅) or silicon dioxide (SiO₂). The inorganic material layer 16 can be formed by, for example, sputtering. When a tantalum oxide layer is used as the inorganic material layer 16, the thickness of the tantalum oxide layer is, for example, 200 nm.

The thickness of the inorganic material layer 16 is preferably not less than 100 nm and less than 500 nm. If the thickness of the inorganic material layer 16 is less than 100 nm, there is a probability that a defect (typically, a void; i.e., a gap between crystal grains) occurs in the aluminum film 18. If the thickness of the inorganic material layer 16 is not less than 500 nm, insulation is likely to occur between the aluminum base 12 and the aluminum film 18 due to the surface condition of the aluminum base 12. To realize anodization of the aluminum film 18 by supplying an electric current from the aluminum base 12 side to the aluminum film 18, the electric current needs to flow between the aluminum base 12 and the aluminum film 18. When employing a configuration where an electric current is supplied from the inside surface of the aluminum base 12 in the shape of a hollow cylinder, it is not necessary to provide an electrode to the aluminum film 18. Therefore, the aluminum film 18 can be anodized across the entire surface, while such a problem does not occur that supply of the electric current becomes more difficult as the anodization advances. Thus, the aluminum film 18 can be anodized uniformly across the entire surface.

To form a thick inorganic material layer 16, it is in general necessary to increase the film formation duration. When the film formation duration is increased, the surface temperature of the aluminum base 12 unnecessarily increases, and as a result, the film quality of the aluminum film 18 deteriorates, and a defect (typically, a void) occurs in some cases. When the thickness of the inorganic material layer 16 is less than 500 nm, occurrence of such a problem can be suppressed.

The aluminum film 18 is, for example, a film which is made of aluminum whose purity is not less than 99.99 mass % (hereinafter, also referred to as “high-purity aluminum film”) as disclosed in WO 2011/125486. The aluminum film 18 is formed by, for example, vacuum evaporation or sputtering. The thickness of the aluminum film 18 is preferably in the range of not less than about 500 nm and not more than about 1500 nm. For example, the thickness of the aluminum film 18 is about 1 μm. The entire disclosure of WO 2011/125486 is incorporated by reference in this specification.

The aluminum film 18 may be an aluminum alloy film disclosed in WO 2013/183576 in substitution for the high-purity aluminum film. The aluminum alloy film disclosed in WO 2013/183576 contains aluminum, a metal element other than aluminum, and nitrogen. In this specification, the “aluminum film” includes not only the high-purity aluminum film but also the aluminum alloy film disclosed in WO 2013/183576. The entire disclosure of WO 2013/183576 is incorporated by reference in this specification.

Using the above-described aluminum alloy film enables to obtain a specular surface whose reflectance is not less than 80%. The average grain diameter of crystal grains that form the aluminum alloy film when viewed in the normal direction of the aluminum alloy film is, for example, not more than 100 nm, and that the maximum surface roughness Rmax of the aluminum alloy film is not more than 60 nm. The content of nitrogen in the aluminum alloy film is, for example, not less than 0.5 mass % and not more than 5.7 mass %. It is preferred that the absolute value of the difference between the standard electrode potential of the metal element other than aluminum which is contained in the aluminum alloy film and the standard electrode potential of aluminum is not more than 0.64 V, and that the content of the metal element in the aluminum alloy film is not less than 1.0 mass % and not more than 1.9 mass %. The metal element is, for example, Ti or Nd. The metal element is not limited to these examples but may be such a different metal element that the absolute value of the difference between the standard electrode potential of the metal element and the standard electrode potential of aluminum is not more than 0.64 V (for example, Mn, Mg, Zr, V, and Pb). Further, the metal element may be Mo, Nb, or Hf. The aluminum alloy film may contain two or more of these metal elements. The aluminum alloy film is formed by, for example, a DC magnetron sputtering method. The thickness of the aluminum alloy film is also preferably in the range of not less than about 500 nm and not more than about 1500 nm. For example, the thickness of the aluminum alloy film is about 1 μm.

After formation of the inverted antiglare structure, anodization and etching are alternately repeated such that an inverted moth-eye structure is formed, whereby a moth-eye mold 100 shown in FIG. 1(d) is obtained. Specifically, the process of forming the inverted moth-eye structure includes: anodizing the surface of the aluminum film 18, thereby forming a porous alumina layer 14 which has a plurality of second recessed portions 14p; thereafter, bringing the porous alumina layer 14 into contact with an etchant, thereby enlarging the plurality of second recessed portions 14p of the porous alumina layer 14; and thereafter, further performing anodization, thereby growing the plurality of second recessed portions 14p. The electrolytic solution used in the anodization is, for example, an aqueous solution which contains an acid selected from the group consisting of oxalic acid, tartaric acid, phosphoric acid, sulfuric acid, chromic acid, citric acid, and malic acid. The etchant used can be an aqueous solution of an organic acid such as formic acid, acetic acid or citric acid or a sulfuric acid, a chromate-phosphate mixture aqueous solution, or an alkaline aqueous solution of sodium hydroxide, potassium hydroxide, or the like.

A series of steps in which anodization and etching are repeated preferably ends with the anodization step. By ending with the anodization step (without performing any subsequent etching step), the second recessed portions 14p can have small bottoms. Such a method for forming the inverted moth-eye structure is disclosed in, for example, Patent Document No. 3.

For example, by alternately repeating the anodization step (electrolytic solution: oxalic acid aqueous solution (concentration: 0.3 mass %, solution temperature: 10° C.), applied voltage: 80 V, duration of application: 55 seconds) and the etching step (etchant: phosphoric aqueous solution (10 mass %, 30° C.), etching duration: 20 minutes) through multiple cycles (e.g., 5 cycles: including 5 anodization cycles and 4 etching cycles), a moth-eye mold 100 is obtained as shown in FIG. 1(d), which includes the porous alumina layer 14 which has the second recessed portions 14p. The porous alumina layer 14 formed under the conditions illustrated herein has such a configuration that second recessed portions 14p whose Dₚ=Dᵢₙₜ is not less than 10 nm and less than 500 nm and whose depth is not less than 10 nm and less than about 1000 nm (1 μm) are in an irregular closely-packed arrangement. The second recessed portions 14p have a generally conical shape and adjoin one another so as to form saddle portions.

Note that a barrier layer is provided under the second recessed portions 14p. The porous alumina layer 14 consists of a porous layer which has the second recessed portions 14p and the barrier layer that is present under the porous layer (aluminum film side), i.e., the bottom part of the recessed portions 14p. It is known that the distance between adjoining second recessed portions 14p (the distance between the centers) is generally twice the thickness of the barrier layer and is generally proportional to the voltage applied during the anodization. Under the porous alumina layer 14, there is an aluminum remnant layer 18r, which is part of the aluminum film 18 which has not been anodized.

As schematically shown in FIG. 1(d), the inverted moth-eye structure formed by the second recessed portions 14p is formed so as to be superposed over the antiglare structure. The “two-dimensional size” of a second recessed portion 14p refers to the area equivalent circle diameter of the recessed portion when viewed in the normal direction of the surface. For example, when a recessed portion has a conical shape, the two-dimensional size of the recessed portion is equivalent to the diameter of the base of the cone. The same applies to the “two-dimensional size” of a raised portion. When the second recessed portions (minute recessed portions) 14p are densely arranged so that there is no gap between adjoining second recessed portions 14p (e.g., the bases of the cones partially overlap each other) as shown in FIG. 1(d), the average adjoining distance of two adjoining second recessed portions 14p (the distance between the centers of adjoining second recessed portions 14p), Dᵢₙₜ, is generally equal to the two-dimensional size of the second recessed portions 14p, Dₚ.

The moth-eye mold 100 can be manufactured as described hereinabove. As will be described later with experimental examples, according to the moth-eye mold 100 of an embodiment of the present invention, an antireflection film can be produced which is capable of exhibiting an antiglare property while providing clear images and preventing itself from appearing whitish when viewed at an oblique viewing angle. According to a manufacturing method of the moth-eye mold 100 of an embodiment of the present invention, a mold for production of an antireflection film which is capable of exhibiting an antiglare property while providing clear images and preventing itself from appearing whitish when viewed at an oblique viewing angle can be efficiently manufactured. The phrase that an antireflection film “appears whitish when viewed at an oblique viewing angle” may refer to that the antireflection film appears whitish and cloudy when viewed at an oblique viewing angle (whitish oblique appearance) and/or that the antireflection film appears whity when viewed at an oblique viewing angle.

Patent Document No. 5 discloses a mold manufacturing method wherein after a surface of an aluminum base is subjected to a blast process, the blast-processed surface of the aluminum base is anodized. In the mold manufacturing method of Patent Document No. 5, the target of the anodization is the aluminum base, and none of an inorganic material layer and an aluminum film is provided over the aluminum base. Patent Document No. 5 discloses that, in the mold manufacturing method of Patent Document No. 5, a spherical abrasive media which does not have a sharp shape is used as the abrasive media (in Patent Document No. 5, referred to as “abrasive used for the blast process”), and hence, a mold for production of an antireflection film which has antireflection property and antiglare property and in which occurrence of glare is suppressed is obtained. In the example of Patent Document No. 5, glass beads are used as the spherical abrasive media which does not have a sharp shape. Patent Document No. discloses that the median particle size of the abrasive media is preferably 35 μm to 150 μm.

However, the present inventors conducted research and found that an antireflection film which was produced using a mold manufactured by the method of Patent Document No. 5 was not prevented from appearing whitish when viewed at an oblique viewing angle. The present inventors conducted various research and found that a mold for production of an antireflection film which is capable of exhibiting an antiglare property while providing clear images and preventing itself from appearing whitish when viewed at an oblique viewing angle can be manufactured by the following method. First, a blasting treatment is performed on the surface of the aluminum base 12 using a generally-spherical abrasive media which contains alumina particles and whose average particle diameter is not less than 10 μm and not more than 40 μm, whereby an inverted antiglare structure is formed at the surface of the aluminum base 12. Thereafter, an aluminum film 18 is formed over the aluminum base 12. Thereby, a moderate inverted antiglare structure can be formed at the surface of the aluminum film 18 (i.e., the surface of the mold base 10). Thus, a mold for production of an antireflection film which is capable of exhibiting an antiglare property while providing clear images and preventing itself from appearing whitish when viewed at an oblique viewing angle can be manufactured.

In the manufacturing method of the moth-eye mold 100 according to an embodiment of the present invention, the average particle diameter of the abrasive media used in the blasting treatment on the surface of the aluminum base 12 is smaller than that in the manufacturing method of Patent Document No. 5. Therefore, by forming the aluminum film 18 over the surface of the aluminum base 12, the effect of moderating the inverted antiglare structure at the surface of the mold base 10 greatly occurs.

Further, the moth-eye mold 100 of an embodiment of the present invention has the following advantages. As previously described, the surface of the aluminum base 12 sometimes has a seam (weld line) or cutting scars. For example, the surface of an aluminum base in the shape of a hollow cylinder which is formed by porthole extrusion can have a seam. A surface of an aluminum base which is subjected to mirror-finishing accompanied by formation of a damaged layer (e.g., bit cutting) can sometimes have cutting scars. In the moth-eye mold 100 of an embodiment of the present invention, the aluminum film 18 is formed over the aluminum base 12.

Although a seam or cutting scars formed in the surface of the aluminum base 12 are reflected in the surface of the aluminum film 18, the seam or cutting scars reflected in the surface of the aluminum film 18 (i.e., the surface of the mold base 10) are more moderate, and less conspicuous, than those formed in the surface of the aluminum base 12. In the manufacturing method of the moth-eye mold 100 according to an embodiment of the present invention, the abrasive media is not propelled toward the surface of the aluminum film 18. Therefore, the abrasive media would not locally destroy the aluminum film 18. Therefore, the thickness of the aluminum film 18 can be decreased (for example, not less than about 500 nm and not more than about 1500 nm).

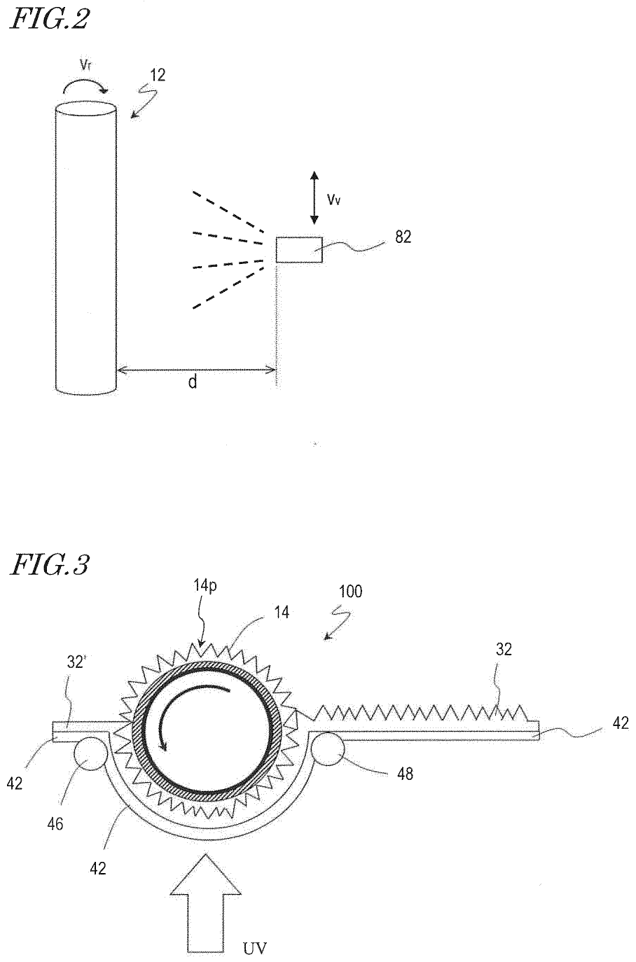

Next, a method for producing an antireflection film with the use of the moth-eye mold 100 is described with reference to FIG. 3. FIG. 3 is a schematic cross-sectional view for illustrating a method for producing an antireflection film according to a roll-to-roll method.

First, a moth-eye mold 100 in the shape of a hollow cylinder is provided. Note that the moth-eye mold 100 in the shape of a hollow cylinder is manufactured according to the above-described manufacturing method.

As shown in FIG. 3, a work 42 over which a UV-curable resin 32′ is applied on its surface is maintained pressed against the moth-eye mold 100, and the UV-curable resin 32′ is irradiated with ultraviolet (UV) light such that the UV-curable resin 32′ is cured. The UV-curable resin 32′ used may be, for example, an acrylic resin. The work 42 may be, for example, a TAC (triacetyl cellulose) film. The work 42 is fed from an unshown feeder roller, and thereafter, the UV-curable resin 32′ is applied over the surface of the work 42 using, for example, a slit coater or the like. The work 42 is supported by supporting rollers 46 and 48 as shown in FIG. 3. The supporting rollers 46 and 48 have rotation mechanisms for carrying the work 42. The moth-eye mold 100 in the form of a cylinder is rotated at a rotation speed corresponding to the carrying speed of the work 42 in a direction indicated by the arrow in FIG. 3.

Thereafter, the moth-eye mold 100 is separated from the work 42, whereby a cured material layer 32 to which an uneven structure of the moth-eye mold 100 (an inverted moth-eye structure and an inverted antiglare structure) is transferred is formed on the surface of the work 42. The work 42 which has the cured material layer 32 formed on the surface is wound up by an unshown winding roller.

A mold releasing treatment may be performed on the moth-eye mold 100 by applying a mold releasing agent to the surface of the moth-eye mold 100 before the work 42 over which the UV-curable resin 32′ is applied on its surface is pressed against the moth-eye mold 100.

The mold releasing agent is, preferably, a compound which contains a (per)fluoropolyether group, a hydrolyzable group (e.g., alkoxy group) and Si atoms. Further, as the mold releasing agent, a perfluoroalkyl-based compound may be contained in addition to at least one compound (perfluoropolyether-based compound). Examples of the perfluoroalkyl-based compound include C₈F₁₇CH₂CH₂Si(OMe)₃, C₆F₁₃CH₂CH₂Si (OMe)₃, and C₄F₉CH₂CH₂Si(OMe)₃. When such a mold releasing agent is applied to the surface of the moth-eye mold 100 beforehand, the moth-eye mold 100 can be easily separated from the cured material layer 32 after the UV-curable resin 32′ is irradiated with ultraviolet light.

When the antireflection film 32 is produced according to the above-described roll-to-roll method, it is preferred that the following steps are performed in order to improve the adhesion between a film base (TAC film or PET film) 42 on which the antireflection film 32 is formed and the antireflection film 32.

A UV-curable resin (e.g., acrylic resin) containing a solvent is applied over a TAC film (to a thickness of, for example, 2 μm to 20 μm). The solvent selected herein is a solvent which is capable of dissolving the surface of the TAC film (e.g., ketone solvent). When the solvent dissolves the surface of the TAC film, a region is formed in which TAC and the UV-curable resin are mixed.

Thereafter, the solvent is removed, and the TAC film is wound around the outer perimeter surface of the moth-eye mold such that the UV-curable resin adheres to the surface.

Then, the UV-curable resin is irradiated with ultraviolet light so as to be cured. Here, the temperature of the UV-curable resin is kept in the range from 30° C. to 70° C.

Thereafter, the TAC film is separated from the moth-eye mold. When necessary, the resin is again irradiated with ultraviolet light.

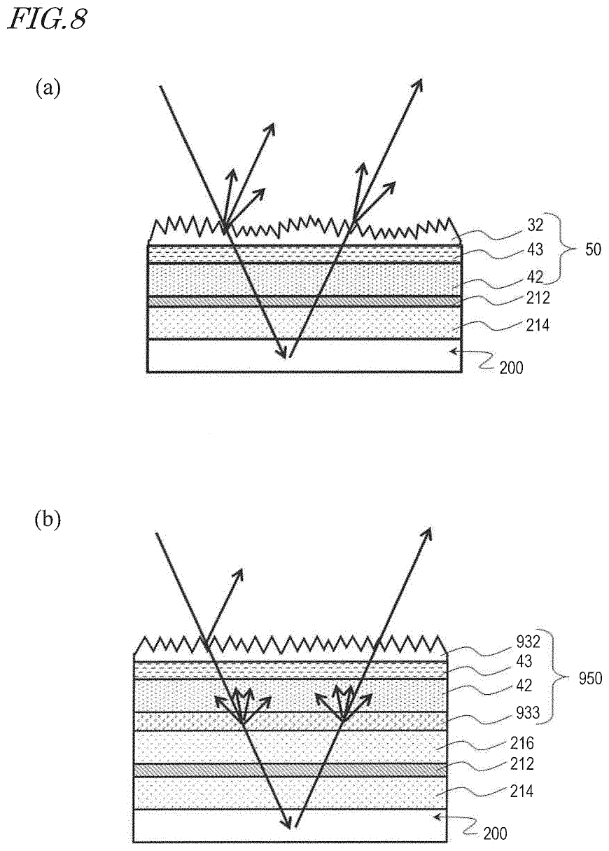

When a hard coat layer is formed on the TAC film as shown in FIG. 8(a) which will be described later, a material of the hard coat layer may contain a solvent which is capable of dissolving the surface of the TAC film. In this case, the UV-curable resin for production of an antireflection film does not need to contain the solvent.

When a PET film is used, it is preferred that a layer of an aqueous primer, e.g., a polyester or acrylic resin, (thickness: 2 μm to 20 μm) is formed before application of the UV-curable resin. Also in this case, the UV-curable resin for production of an antireflection film does not need to contain the solvent.

Hereinafter, a moth-eye mold and a manufacturing method of the moth-eye mold according to an embodiment of the present invention are described in more detail with experimental examples.

[Experiment with Small Aluminum Piece]

An inverted antiglare structure formed at the surface of the aluminum base 12 by a blasting treatment is described with reference to FIG. 4(a) and FIG. 4(b). The inverted antiglare structure was formed by performing a blasting treatment step on a surface of a small aluminum piece. FIG. 4(a) and FIG. 4(b) are SEM images of the surfaces of small aluminum pieces each having an inverted antiglare structure formed by propelling an abrasive media toward the surface (the full scale in the SEM images is 20.0 μm).

FIG. 4(a) and FIG. 4(b) show inverted antiglare structures each of which is formed at the mirror-finished surface of the small aluminum piece. The inverted antiglare structure was formed at a surface of the small aluminum piece corresponding to the aluminum base 12 of FIG. 1(a). Herein, as the Al—Mg—Si based aluminum alloy, a 15 mm thick small aluminum piece in the shape of a square of about 5 cm on each side, which was made of JIS A6063, was used. JIS A6063 has the following composition (mass %).

Si: 0.20-0.60%; Fe: not more than 0.35%; Cu: not more than 0.10%; Mn: not more than 0.10%; Mg: 0.45-0.9%; Cr: not more than 0.10%; Zn: not more than 0.10%; Ti: not more than 0.10%; the other elements: each element is not more than 0.05%; the entirety of the other elements is not more than 0.15%; the remaining part: Al.

The blasting treatment was performed under varying conditions, whereby the inverted antiglare structure of FIG. 4(a) and the inverted antiglare structure of FIG. 4(b) were obtained. The conditions for the blasting treatment step performed for obtaining the inverted antiglare structures of FIG. 4(a) and FIG. 4(b) (the conditions for propelling of the abrasive media and the type of the abrasive media) are shown in TABLE 6. TABLE 6 shows together the conditions for the blasting treatment step and the type of aluminum that is the object of the blasting treatment (i.e., aluminum base 12) in the experimental examples in the specification.

As seen from the SEM images of FIG. 4(a) and FIG. 4(b), the inverted antiglare structure formed by propelling the abrasive media toward the surface of the aluminum base 12 has a plurality of first recessed portions 12a. No regularity can be seen in the arrangement of the plurality of first recessed portions 12a. It can also be seen that the distribution of the two-dimensional size of the plurality of first recessed portions 12a is wide. Herein, the “two-dimensional size” of the first recessed portions 12a refers to the area equivalent circle diameter. It can be estimated from the SEM image of FIG. 4(a) that the two-dimensional size of the plurality of first recessed portions 12a ranges from 2 μm to 10 μm, the average two-dimensional size of the plurality of first recessed portions 12a is 5 μm, and the adjoining distance of the plurality of first recessed portions 12a (the distance between the centers of adjoining first recessed portions 12a) is not less than 2 μm and not more than 10 μm. It can be estimated from the SEM image of FIG. 4(b) that the two-dimensional size of the plurality of first recessed portions 12a ranges from 5 μm to 20 μm, the average two-dimensional size of the plurality of first recessed portions 12a is 10 μm, and the adjoining distance of the plurality of first recessed portions 12a (the distance between the centers of adjoining first recessed portions 12a) is not less than 1 μm and not more than 10 μm.

For example, the two-dimensional size of the plurality of first recessed portions 12a of the inverted antiglare structure of FIG. 4(a) is smaller than the average particle diameter of the abrasive media. In the inverted antiglare structure of FIG. 4(b), the average two-dimensional size of the plurality of first recessed portions 12a is smaller than the average particle diameter of the abrasive media.

The first recessed portions 12a are densely and irregularly arranged, for example, as schematically shown in FIG. 1(b). The inverted antiglare structure does not have a flat portion between the first recessed portions 12a. The arithmetic mean roughness Ra of the surface 12s that has the inverted antiglare structure formed by propelling the abrasive media toward the surface of the aluminum base 12 is, for example, not less than 0.05 μm and not more than 0.3 μm.

As previously described with reference to FIG. 1(c), an inorganic material layer 16 is formed on the surface of the aluminum base 12 which has the inverted antiglare structure, and an aluminum film 18 is formed on the inorganic material layer 16. Thereby, a structure in which the inverted antiglare structure of the surface 12s of the aluminum base 12 is reflected is formed at the surface 18s of the aluminum film 18. The aluminum film 18 has the inverted antiglare structure which includes the plurality of third recessed portions 18a. Since the plurality of third recessed portions 18a are a reflection of the plurality of first recessed portions 12a, the dimensions of the plurality of third recessed portions 18a (e.g., two-dimensional size, depth, adjoining distance) can be equal to those of the plurality of first recessed portions 12a. Note that, however, the inverted antiglare structure formed at the surface 18s of the aluminum film 18 is more moderate than the inverted antiglare structure formed at the surface 12s of the aluminum base 12. For example, the ridge of the plurality of third recessed portions 18a is more moderate (not sharper) than the ridge of the plurality of first recessed portions 12a. Therefore, the surface 18s of the aluminum film 18 which has the inverted antiglare structure is more moderate than the surface 12s of the aluminum base 12 which has the inverted antiglare structure. For example, the surface roughness of the surface 18s of the aluminum film 18 may be smaller than the surface roughness of the surface 12s of the aluminum base 12.

The two-dimensional size of the plurality of third recessed portions 18a also refers to the area equivalent circle diameter. The same also applies to the “two-dimensional size” of raised portions which are the inverse of the third recessed portions 18a.

In the inverted antiglare structure of a mold of an embodiment of the present invention, the two-dimensional size of the plurality of third recessed portions 18a is, for example, not less than 1 μm and not more than 12 μm or may be, for example, not less than 3 μm and not more than 12 μm. The depth of the plurality of third recessed portions 18a is, for example, not less than 1 μm and not more than 4 μm. The aspect ratio of the depth to the two-dimensional size of the plurality of third recessed portions 18a is, for example, not less than 0.05 and not more than 0.5.

[Examination of Conditions for Blasting Treatment Step]

The conditions for the blasting treatment step (the conditions for propelling of the abrasive media and the type of the abrasive media) which are suitable for manufacture of a mold for production of an antireflection film which is capable of exhibiting an antiglare property while providing clear images and preventing itself from appearing whitish when viewed at an oblique viewing angle were examined.

The blasting treatment step was performed on the surface of the aluminum base 12, whereby an aluminum base 12 was produced which had an inverted antiglare structure at its surface. Herein, mold samples were manufactured without forming any of an inorganic material layer and an aluminum film over the aluminum base 12. The mold samples were manufactured with varying conditions for the blasting treatment step to be performed on the surface of the aluminum base 12. The surface of the mold samples was provided with a mold releasing treatment by applying a mold releasing agent to the surface. The mold releasing treatment was specifically performed as follows. First, a mold releasing agent (OPTOOL DSX manufactured by DAIKIN INDUSTRIES, LTD.) was diluted with “S-135” manufactured by Fluoro Technology. In the resultant dilution, the concentration of the mold releasing agent was 0.1%. Then, the mold samples were immersed in the dilution of the mold releasing agent for 3 minutes, whereby the mold releasing agent was applied to the surface of the mold samples. Thereafter, the mold samples with the applied mold releasing agent over the surface were annealed at 150° C. for one hour and rinsed with “S-135” manufactured by Fluoro Technology. After the mold releasing treatment, an acrylic UV-curable resin was applied to the surface of the mold samples and cured by irradiation with ultraviolet light while it is transferred onto a TAC film. The antiglare function of the resultant sample films No. 1 to No. 4 which had an antiglare structure was examined.

A film which does not have a moth-eye structure but has only an antiglare structure, such as the sample film used herein, is also referred to as “antiglare film”. The conditions for the blasting treatment step performed on the mold samples for production of antiglare films No. 1 to No. 4 are shown in TABLE 6.

TABLE 1 shows the results of examination of antiglare films No. 1 to No. 4 as to the antiglare function.

TABLE 1

| antiglare film | | No. 1 | No. 2 | No. 3 | No. 4 |
|---|---|---|---|---|---|
| abrasive media | | alumina | alumina | alumina | glass |
| | | | | | beads |
| haze value of antireflection | | 11.5 | 8.6 | 26.8 | 19.7 |
| film sheet [%] | | | | | |
| arithmetic mean roughness Ra | | 0.07 | 0.06 | 0.13 | 0.14 |
| of mold surface [μm] | | | | | |
| from front | glare | OK | OK | OK | NG |
| direction | | | | | |
| from front | moiré | OK | OK | OK | OK |
| direction | | | | | |
| at oblique viewing | whitish | OK | OK | NG | NG |
| angle | | | | | |

In TABLE 1, the sections of “glare”, “moiré” and “whitish” show the results of subjective evaluation by eye observation of an antireflection film sheet attached to the viewer side surface of the display panel of a liquid crystal television set (AQUOS LC-60UD1 manufactured by Sharp Corporation, 60 inches). The subjective evaluation was made by conducting a hearing on ten people. The section of “glare” shows the results of evaluation as to whether or not he/she noticed glaring of the display surface when he/she viewed the antireflection film sheets in the normal direction of the surface. The section of “moiré” shows the results of evaluation as to whether or not he/she noticed moiré fringes across the display surface when he/she viewed the antireflection film sheets in the normal direction of the surface. The section of “whitish” shows the results of evaluation as to whether or not the antireflection film sheets appeared whitish (whitish and cloudy) when he/she viewed the antireflection film sheets at the polar angle of 80° from the normal direction of the surface.

In TABLE 1, the section of “haze value of antireflection film sheet” shows the results of measurement of the haze value of the antireflection film sheets with the use of an integrating sphere haze meter NDH-2000 manufactured by NIPPON DENSHOKU INDUSTRIES CO., LTD. Collimated light was cast. The haze value refers to the ratio of the diffuse transmitted light to the total transmitted light, where the total transmitted light is the sum of the linear transmitted light and the diffuse transmitted light.

In TABLE 1, the section of “arithmetic mean roughness Ra of mold surface” shows the results of measurement of the arithmetic mean roughness Ra of the mold surface with the use of a surface roughness measuring system (product name: SURFCOM 480A manufactured by TOKYO SEIMITSU CO., LTD.).

Antiglare film No. 1 and antiglare film No. 2 were prevented from appearing whitish when viewed at an oblique viewing angle, and when viewed from the front direction, occurrence of glare was suppressed. Antiglare film No. 3 had a greater haze value than antiglare film No. 1 and antiglare film No. 2 and appeared whitish when viewed at an oblique viewing angle.

Comparing antiglare film No. 3 and antiglare film No. 4, there was a difference in the effect of suppressing occurrence of glare, although they were at generally equal levels in the arithmetic mean roughness Ra of the mold surface. It can be estimated that using alumina particles as the abrasive media is probably preferred from the viewpoint of suppressing occurrence of glare. When the abrasive medias used herein are compared as to the average particle diameter, glass beads have a greater average particle diameter than alumina particles. This can be one of the reasons that occurrence of glare was not suppressed. As seen from TABLE 6, the average particle diameter of the alumina particles used for manufacture of the mold samples which are for production of antiglare films No. 1 to No. 3 was 17 μm, while the average particle diameter of the glass beads used for manufacture of the mold sample which is for production of antiglare film No. 4 was 23 μm.

As seen from the results of antiglare films No. 1 to No. 3 for which alumina particles were used as the abrasive media, there is a correlation between the haze values of the antireflection film sheets and the arithmetic mean roughness Ra of the mold surface.

[Production of Antireflection Film of Embodiment of Present Invention]

The antireflection film sheet of Example 1 and the antireflection film sheet of Reference Example 1 were produced under the conditions for the blasting treatment step which were determined with reference to the results shown above in TABLE 1.

The characteristics of an antireflection film of an embodiment of the present invention are described with reference to FIG. 5 and TABLE 2. FIG. 5(a) and FIG. 5(b) show optical images of a display panel (liquid crystal television set, product name: AQUOS LC-60UD1 manufactured by Sharp Corporation, 60 inches) with the antireflection film sheet of Example 1 (center), the antireflection film sheet of Reference Example 1 (right) and the antireflection film sheet of Comparative Example 1 (left) being adhered to the surface of the display panel. FIG. 5(a) shows the optical image viewed in the normal direction of the surface. FIG. 5(b) shows the optical image viewed at an oblique viewing angle (polar angle: 60°).

The antireflection film sheet of Example 1 and the antireflection film sheet of Reference Example 1 were produced by the method previously described with reference to FIG. 3 using the moth-eye mold 100 manufactured by the method which has previously been described with reference to FIG. 1 and FIG. 2. The moth-eye mold for production of the antireflection film sheet of Example 1 was manufactured by performing the blasting treatment under the same conditions as those for the blasting treatment step performed on the mold sample which was for production of antiglare film No. 2 which has previously been described. The moth-eye mold for production of the antireflection film sheet of Reference Example 1 was manufactured by performing the blasting treatment under the same conditions as those for the blasting treatment step performed on the mold sample which was for production of antiglare film No. 3 which has previously been described.

The antireflection film sheet of Example 1 and the antireflection film sheet of Reference Example 1 have the same configuration as that of the antireflection film sheet 50 shown in FIG. 8(a) which will be described later.

Specifically, the antireflection film sheet of Example 1 and the antireflection film sheet of Reference Example 1 include a base film (TAC film), a hard coat layer provided over the base film, and an antireflection film which has an antiglare structure and a moth-eye structure at its surface.

The antireflection film sheet of Comparative Example 1 is a presently commercially available antireflection film sheet which has an antireflection function and an antiglare function. The antireflection film sheet of Comparative Example 1 does not have a moth-eye structure.

TABLE 2 shows the results of evaluation as to the antireflection function and the antiglare function of the antireflection film sheet of Example 1, the antireflection film sheet of Reference Example 1 and the antireflection film sheet of Comparative Example 1.

TABLE 2

| | | | Reference | Comparative |
|---|---|---|---|---|
| | | Example 1 | Example 1 | Example 1 |
| moth-eye structure | | YES | YES | NO |
| from | blurring of | ◯ | ⊚ | ◯ |
| front | reflected image | | | |
| direction | whitish | NO | YES | NO |
| at | whitish | NO | YES | NO |
| oblique | | | | |
| viewing | | | | |
| angle | | | | |

| | | | |
|---|---|---|---|
| haze value of antireflection | 23 | 51 | 0.6 |
| film sheet [%] | | | |
| arithmetic mean roughness Ra | 0.09 | 0.15 | — |
| of mold surface [μm] | | | |
| specular gloss at 20° | 0.1 | 0.05 | 1.1 |
| specular gloss at 60° | 4.0 | 1.5 | 11.0 |
| specular gloss at 85° | 68.4 | 48.3 | 79.1 |

In TABLE 2, the sections of “blurring of reflected image” and “whitish” show the results of subjective evaluation by eye observation, while the sections of “haze value”, “specular gloss at 20°”, “specular gloss at 60°” and “specular gloss at 85°” show measurement results. The subjective evaluation was made by conducting a hearing on ten people.

In TABLE 2, the section of “blurring of reflected image” shows the results of evaluation of the antireflection film sheets as to the antiglare property, which were evaluated by eye observation on the degree of blurring of the contour of an image reflected in the antireflection film sheets when the antireflection film sheets were viewed from the front direction (the normal direction of the surface). “0” means that the degree of blurring of the contour of the reflected image was appropriate so that clear images can be achieved. “⊚” means that the contour of the reflected image was excessively blurred in consideration of the purpose of achieving clear images. Note that, however, as a matter of course, in some cases, an antireflection film sheet evaluated as “⊚” can be suitably used as an antireflection film which has a higher antiglare function.

In TABLE 2, the section of “whitish” shows the results of evaluation by eye observation as to whether or not the antireflection film sheets appeared whitish (whitish and cloudy). The section of “from front direction” shows the results obtained when the antireflection film sheets were viewed in the normal direction of the surface. The section of “oblique viewing angle” shows the results obtained when the antireflection film sheets were viewed at the polar angle of 80° from the normal direction of the surface.

The haze values in TABLE 2 were measured using an integrating sphere haze meter NDH-2000 manufactured by NIPPON DENSHOKU INDUSTRIES CO., LTD. Collimated light was cast. The haze value refers to the ratio of the diffuse transmitted light to the total transmitted light, where the total transmitted light is the sum of the linear transmitted light and the diffuse transmitted light. The specular gloss at 20°, the specular gloss at 60° and the specular gloss at 85° were measured with the film sheet attached to a black acrylic plate using a gloss meter (product name: GS-4K manufactured by Suga Test Instruments Co., Ltd.).

The antireflection film sheet of Example 1 and the antireflection film sheet of Reference Example 1 have the same configuration as that of the antireflection film sheet 50 shown in FIG. 8(a). Specifically, the surface structure of the antireflection film 32 of the antireflection film sheet 50 exhibits an antireflection function and an antiglare function. Therefore, it can be expected that the evaluation results shown in TABLE 2 as to the antireflection function and the antiglare function of the antireflection film sheets of Example 1 and Reference Example 1 are equal to the evaluation as to the antireflection function and the antiglare function of the antireflection films of Example 1 and Reference Example 1.

In the antireflection film sheet of Example 1, the degree of blurring of the contour of a reflected image as viewed from the front direction is appropriate so that clear images can be achieved. The antireflection film sheet of Example 1 has a low haze value. Both when the antireflection film sheet of Example 1 is viewed from the front direction and when the antireflection film sheet of Example 1 is viewed at an oblique viewing angle, the antireflection film sheet does not appear whitish. Since the antireflection film sheet of Example 1 has a moth-eye structure, the antireflection film sheet of Example 1 exhibits a sufficient antireflection function even when viewed at an oblique viewing angle. Since the antireflection film sheet of Example 1 has a moth-eye structure, the antireflection film sheet of Example 1 can realize an excellent black display quality (i.e., the luminance in the black display state is low).

In comparison, the antireflection film sheet of Reference Example 1 has a high haze value and therefore appears whitish when viewed from the front direction. The antireflection film sheet of Reference Example 1 appears whitish also when viewed at an oblique viewing angle (whitish oblique appearance). In the antireflection film sheet of Reference Example 1, the contour of the reflected image is excessively blurred in consideration of the purpose of achieving clear images.

The antireflection film sheet of Comparative Example 1 has a lower haze value than the antireflection film sheet of Example 1 and is prevented from appearing whitish when viewed from the front direction and when viewed at an oblique viewing angle. However, the antireflection film sheet of Comparative Example 1 does not have a moth-eye structure and therefore has a low black display quality (i.e., the luminance in the black display state is high) as compared with the antireflection film sheet of Example 1. Further, since the antireflection film sheet of Comparative Example 1 does not have a moth-eye structure, the antireflection effect of the antireflection film sheet of Comparative Example 1 for oblique viewing angles is insufficient.

Thus, an antireflection film of an embodiment of the present invention is capable of exhibiting an antiglare property while providing clear images and preventing itself from appearing whitish when viewed at an oblique viewing angle.

The specular gloss at 60° of the antireflection film sheet of Example 1 is 4.0. The specular gloss at 85° of the antireflection film sheet of Example 1 is 68.4. The specular gloss at 20° of the antireflection film sheet of Example 1 is 0.1. The antireflection film sheet of Example 1 has a smaller specular gloss at 60° and a smaller specular gloss at 85° than the antireflection film sheet of Comparative Example 1. The antireflection film sheet of Example 1 has a better antiglare property for oblique viewing angles than the antireflection film sheet of Comparative Example 1. It is also seen from FIG. 5(b) that the antireflection film sheet of Example 1 prevents reflection of images which can occur when viewed at an oblique viewing angle as compared with the antireflection film sheet of Comparative Example 1.

The antireflection film sheet of Reference Example 1 also has a smaller specular gloss at 60° and a smaller specular gloss at 85° than the antireflection film sheet of Comparative Example 1. The antireflection film sheet of Reference Example 1 has a better antiglare property for oblique viewing angles than the antireflection film sheet of Comparative Example 1. The specular gloss at 20° of the antireflection film sheet of Reference Example 1 is 0.05, which is smaller than that of the antireflection film sheet of Example 1. The antireflection film sheet of Reference Example 1 is inferior to the antireflection film sheet of Example 1 from the viewpoint of providing clear images.

An antireflection film of an embodiment of the present invention preferably has a specular gloss at 60° of not less than 1.0 and not more than 10.0 and a specular gloss at 20° of not less than 0.01 and not more than 1.0. The specular gloss at 85° of an antireflection film of an embodiment of the present invention is preferably not less than 50.0 and not more than 75.0. In an antireflection film of an embodiment of the present invention, for example, the specular gloss at 20° is preferably not less than 0.01 and not more than 0.1 when the specular gloss at 60° is assumed to be 1. In an antireflection film of an embodiment of the present invention, for example, the specular gloss at 20° is preferably not less than 0.001 and not more than 0.005 when the specular gloss at 85° is assumed to be 1. Such an antireflection film is capable of exhibiting an antiglare property while providing clear images and preventing itself from appearing whitish when viewed at an oblique viewing angle. The haze value of an antireflection film of an embodiment of the present invention is preferably not less than 5 and not more than 30. The haze value of the antireflection film may be, for example, not less than 2 and not more than 40.

According to an antireflection film production method of an embodiment of the present invention, a film which is capable of exhibiting an antiglare property while providing clear images and preventing itself from appearing whitish when viewed at an oblique viewing angle can be efficiently produced. The antireflection film production method of an embodiment of the present invention is excellent in mass productivity.

The mold for production of the antireflection film sheet of Example 1 and the mold for production of the antireflection film sheet of Reference Example 1 were manufactured by performing a blasting treatment step under the same conditions as those for the mold samples used for production of antiglare film No. 2 and antiglare film No. 3. It is estimated that the difference between the haze value of the antireflection film sheet of Example 1 and the haze value of antiglare film No. 2 is attributed to the presence/absence of the moth-eye structure. For the same reason, the haze value of the antireflection film sheet of Reference Example 1 is different from the haze value of antiglare film No. 3.

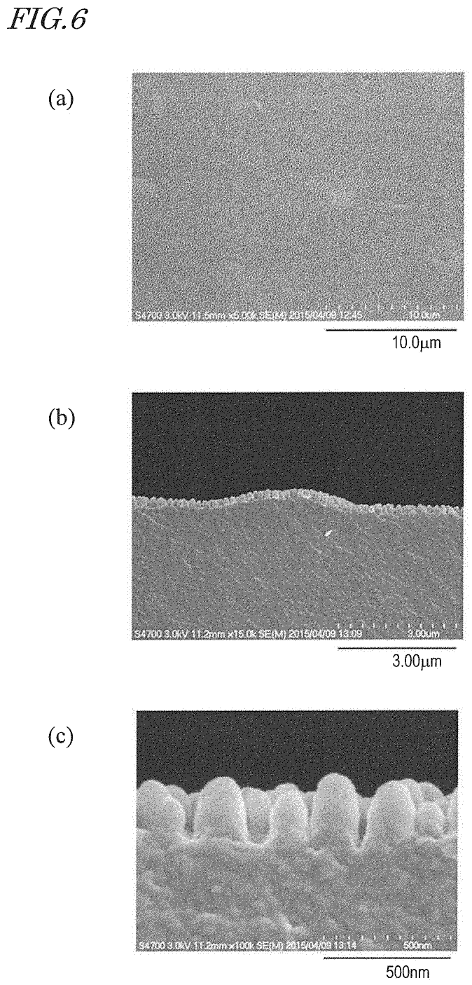

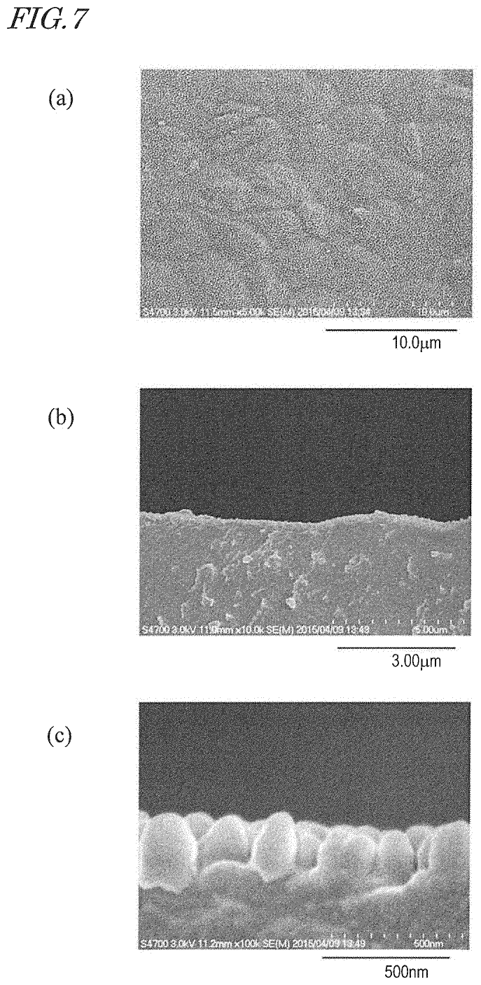

FIG. 6 and FIG. 7 show SEM images of the antireflection film sheet of Example 1 and the antireflection film sheet of Reference Example 1. FIG. 6(a) to FIG. 6(c) are SEM images of the antireflection film sheet of Example 1. FIG. 6(a) is a SEM image of the surface of the antireflection film sheet of Example 1 as viewed in a vertical direction (the full scale in the SEM image is 10.0 μm). FIG. 6(b) is a cross-sectional SEM image of the antireflection film sheet of Example 1 (the full scale in the SEM image is 3.0 μm). FIG. 6(c) is a cross-sectional SEM image of the antireflection film sheet of Example 1 (the full scale in the SEM image is 500 nm). FIG. 7(a) to FIG. 7(c) are SEM images of the antireflection film sheet of Reference Example 1. FIG. 7(a) is a SEM image of the surface of the antireflection film sheet of Reference Example 1 as viewed in a vertical direction (the full scale in the SEM image is 10.0 μm). FIG. 7(b) is a cross-sectional SEM image of the antireflection film sheet of Reference Example 1 (the full scale in the SEM image is 3.0 μm). FIG. 7(c) is a cross-sectional SEM image of the antireflection film sheet of Reference Example 1 (the full scale in the SEM image is 500 nm).

As seen from FIG. 6(a) and FIG. 6(b), the moth-eye structure is superposed over the antiglare structure. The antiglare structure is realized by inverting the inverted antiglare structure which has the plurality of third recessed portions 18a. That is, the antiglare structure consists of first raised portions which are obtained by inverting the plurality of third recessed portions 18a. As seen from FIG. 6(a) and FIG. 6(b), in the antireflection film sheet of Example 1, the two-dimensional size of the first raised portions is not less than 1 μm and not more than 5 μm, and the adjoining distance of the first raised portions (the distance between the centers of adjoining first raised portions) is about 10 μm. The moth-eye structure is realized by inverting the inverted moth-eye structure which has a plurality of second recessed portions 14p. Specifically, the moth-eye structure consists of second raised portions which are obtained by inverting the plurality of second recessed portions 14p. As seen from FIG. 6(c), the two-dimensional size and the adjoining distance (corresponding to Dₚ=Dᵢₙₜ) of the second raised portions are about 200 nm, and the height of the second raised portions (corresponding to the depth of the second recessed portions 14p) is about 240 nm on average.

As seen from FIG. 7(a), in the antireflection film sheet of Reference Example 1, the two-dimensional size of the first raised portions is not less than 0.1 μm and not more than 2 μm, and the adjoining distance of the first raised portions is not less than 1 μm and not more than 5 μm. The adjoining distance of the first raised portions of the antireflection film of FIG. 7 is smaller than the adjoining distance of the first raised portions of the antireflection film of FIG. 6. As seen from FIG. 7(c), the two-dimensional size and the adjoining distance (corresponding to Dₚ=Dᵢₙₜ) of the second raised portions are about 200 nm, and the height of the second raised portions (corresponding to the depth of the second recessed portions 14p) is about 236 nm on average.

In the antiglare structure of an antireflection film of an embodiment of the present invention, the two-dimensional size of the plurality of first raised portions is, for example, not less than 1 μm and not more than 12 μm. The height of the plurality of first raised portions is, for example, not less than 1 μm and not more than 4 μm. The aspect ratio of the depth to the two-dimensional size of the plurality of first raised portions is, for example, not less than 0.05 and not more than 0.5.

As described above, an antireflection film of an embodiment of the present invention is capable of exhibiting an antiglare property while providing clear images and preventing itself from appearing whitish when viewed at an oblique viewing angle. Such an effect is not achieved in conventional antireflection films (or antireflection film sheets) as will be described in the following paragraphs.

The antireflection film sheets of Comparative Example 2 to Comparative Example 9 are described with reference to TABLE 3. TABLE 3 shows the evaluation results as to the antireflection function and the antiglare function of the antireflection film sheets of Comparative Example 2 to Comparative Example 9.

TABLE 3

| | | Comparative | Comparative | Comparative | Comparative | Comparative | Comparative | Comparative |
|---|---|---|---|---|---|---|---|---|
| | | Example | Example | Example | Example | Example | Example | Example |
| | | 2 | 3 | 4 | 5 | 6 | 7 | 9 |
| type | | external | external | no AG | internal | internal | internal | internal |
| haze value [%] | | — | 3.17 | 0.40 | 18.52 | 30.96 | 43.42 | 6.92 |
| from | blurring | ⊚ | ◯ | X | ◯ | ◯ | ◯ | X |
| front | of reflected | | | | | | | |
| direction | image | | | | | | | |
| | whitish | X | X | ◯ | ◯ | Δ | Δ | ◯ |
| at | whitish | X | ◯ | ◯ | Δ | Δ | X | ◯ |
| oblique | | | | | | | | |
| viewing | | | | | | | | |
| angle | | | | | | | | |

“Blurring of reflected image”, “whitish” and “haze value” were evaluated or measured likewise as described for TABLE 2. As for “blurring of reflected image”, “x” means that the contour of an image reflected in the antireflection film sheet is not substantially blurred. That is, an antireflection film sheet which is classified as “x” for “blurring of reflected image” does not have an antiglare property. As for “whitish” for “oblique viewing angle”, “o” means that whitening would not occur at an oblique viewing angle, “Δ” means that the antireflection film sheet is somewhat whitish when viewed at a polar angle of 70° or greater, and “x” means that the antireflection film sheet is whitish when viewed at a polar angle of about 60°. “Whitish” for “from front direction” is the result obtained when the antireflection film sheet is viewed from the front direction. “o” means that the antireflection film sheet is not whitish. “Δ” means that the antireflection film sheet is somewhat whitish. “x” means that the antireflection film sheet is obviously whitish.

In TABLE 3, “type” refers to the type of the configuration of the antireflection film sheets of Comparative Example 2 to Comparative Example 9. As described with reference to FIG. 8, antireflection film sheets which have an antiglare function can be generally classified by their configurations into “external haze type (or non-filler type)” and “internal haze type (or filler type)”.

The type of the antireflection film sheets is described with reference to FIG. 8. FIG. 8(a) and FIG. 8(b) are schematic cross-sectional views of antireflection film sheets which have an antiglare function. FIG. 8(a) is a schematic cross-sectional view of the antireflection film sheet 50 which has an antiglare structure at its surface. FIG. 8(b) is a schematic cross-sectional view of the antireflection film sheet 950 which has an antiglare function layer at a level more internal than the surface. In TABLE 3, the “haze value” was measured with the antireflection film sheet 50 of FIG. 8(a) or the antireflection film sheet 950 of FIG. 8(b) being adhered to a glass plate.

In FIG. 8(a), the antireflection film sheet 50 includes a base film (e.g., TAC film) 42, a hard coat layer 43, and an antireflection film 32 which has a moth-eye structure and an antiglare structure at its surface. The antireflection film sheet 50 is closer to a viewer than a polarizing layer (e.g., PVA) 212 which is provided on the viewer side of a display panel 200. Due to the antiglare structure at the surface of the antireflection film 32, the antireflection film sheet 50 exhibits an antiglare property. An antireflection film sheet which has an antiglare structure at its surface is also referred to as “external haze type antireflection film sheet”. An antireflection film of an embodiment of the present invention can be a constituent of an external haze type antireflection film sheet. The polarizing layer 212 is protected with the base film (e.g., TAC film) 42 and a protection layer (e.g., TAC) 214. The display panel which includes the antireflection film sheet 50 is not limited to the illustrated configuration but may have the following configuration. A polarizer which includes a polarizing layer and protection layers provided on opposite sides of the polarizing layer may be provided on the viewer side of the display panel 200, and an antireflection film sheet 50 may be adhered to the viewer side of the polarizer via an adhesive layer.

In FIG. 8(b), the antireflection film sheet 950 includes an inner haze layer 933, a base film (e.g., TAC film) 42, a hard coat layer 43, and an antireflection film 932 which has a moth-eye structure at its surface. The inner haze layer 933 has a light-scattering property. The inner haze layer 933 is made of, for example, an adhesive agent which contains light-scattering particles. The antireflection film sheet 950 is closer to a viewer than a polarizing layer (e.g., PVA layer) 212 which is provided on the viewer side of the display panel 200. Due to the inner haze layer 933, the antireflection film sheet 950 exhibits an antiglare property. An antireflection film sheet which has a light-scattering layer at a position more internal than the surface of the antireflection film sheet is also referred to as “internal haze type antireflection film sheet”. The polarizing layer 212 is supported by supporting layers (e.g., TAC) 214 and 216. A set of the polarizing layer 212 and the supporting layers 214 and 216 is also referred to as “polarizer”. An adhesive layer may be provided between the polarizer that includes the polarizing layer 212 and the supporting layers 214 and 216 and the antireflection film sheet 950.

As shown in TABLE 3, the antireflection film sheets of Comparative Example 2 and Comparative Example 3 are of the external haze type, and the antireflection film sheets of Comparative Example 5 to Comparative Example 9 are of the internal haze type. The antireflection film sheets of Comparative Example 2 and Comparative Example 3 have the same configuration as that of the antireflection film sheet 50 shown in FIG. 8(a). The antireflection film sheets of Comparative Example 5 to Comparative Example 9 have the same configuration as that of the antireflection film sheet 950 shown in FIG. 8(b). The antireflection film sheet of Comparative Example 4 does not have an antiglare function.

As seen from TABLE 2 and TABLE 3, generally, when viewed from the front direction and when viewed at an oblique viewing angle, the antireflection film sheets are liable to appear whitish as the haze value increases, irrespective of whether they are of the external haze type or the internal haze type. Meanwhile, for the internal haze type antireflection film sheets, particularly for the antireflection film sheets of Comparative Example 5 to Comparative Example 9, the antireflection film sheets tend to appear more whitish when viewed at an oblique viewing angle than when viewed in the normal direction of the surface. Since the internal haze type antireflection film sheets have an inner haze layer which has an antiglare function at a position more internal than the surface, they disadvantageously appear whitish particularly when viewed at an oblique viewing angle rather than when viewed in the normal direction of the surface.

Meanwhile, the external haze type antireflection film sheet has an antiglare structure at its surface and, therefore, such a problem is unlikely to occur. The present inventors arrived at an antireflection film which can solve the above-described problems and a production method of such an antireflection film. In one embodiment of the present invention, the present inventors developed an antireflection film which is comparable to the antireflection film sheet of Comparative Example 5 in respect of the degree of blurring of the contour of an image reflected in the antireflection film, and a production method of such an antireflection film. The reason why the antireflection film sheet of Comparative Example 5 is considered as a benchmark is that the clear images provided through the antireflection film sheet of Comparative Example 5 is preferred in at least a part of the market. Note that the degree of blurring of the contour of an image reflected in the antireflection film (i.e., the degree of the antiglare property of the antireflection film) is not limited to this example. As a matter of course, it may be changed according to the purpose of use of the antireflection film or the form of the antireflection film when it is used.

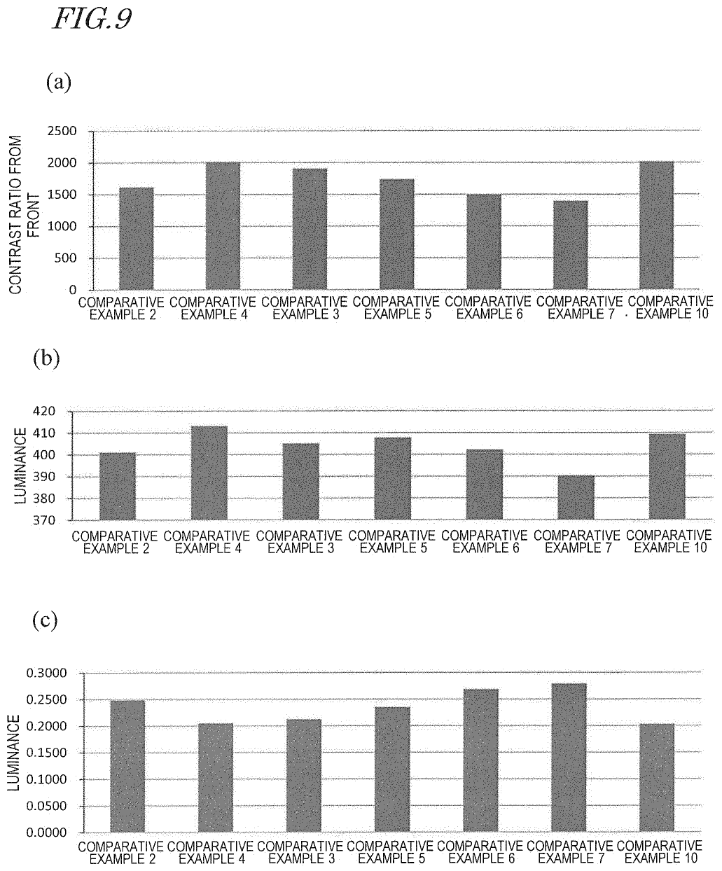

The properties of the antireflection film sheets of Comparative Example 2 to Comparative Example 7 and Comparative Example 10 as viewed from the front direction are further described with reference to FIG. 9. FIG. 9(a) shows the contrast ratio under a high illuminance (100 Lux) of the antireflection film sheets of Comparative Example 2 to Comparative Example 7 and Comparative Example 10 as viewed from the front direction. FIG. 9(b) shows the luminance in the white display state of the antireflection film sheets of Comparative Example 2 to Comparative Example 7 and Comparative Example 10 as viewed from the front direction. FIG. 9(c) shows the luminance in the black display state of the antireflection film sheets of Comparative Example 2 to Comparative Example 7 and Comparative Example 10 as viewed from the front direction. The antireflection film sheet of Comparative Example 10 is a low-reflection film (LR film) which does not have an antiglare function.

The luminance in the white display state and the luminance in the black display state were measured as follows, and the photopic contrast ratio was calculated from the ratio between the luminance in the white display state and the luminance in the black display state as follows. The following measurement method is based on ARIB TR-B28 of the Association of Radio Industries and Businesses. For the luminance in the white display state, the luminance was measured in a darkroom using a luminance colorimeter (product name: BM-5A, manufactured by TOPCON TECHNOHOUSE CORPORATION) with the input signals of Y level 940 (white 100%), and C_{B} and C_{R} level 512. For the luminance in the black display state, the luminance was measured in a darkroom using a luminance colorimeter (product name: BM-5A, manufactured by TOPCON TECHNOHOUSE CORPORATION) with the input signals of Y level 64 (black), and C_{B} and C_{R} level 512. For the photopic contrast ratio, the luminances of a portion of Y level 940 (white 100%) and a portion of Y level 64 (black) (both C_{B} and C_{R} level 512) were measured in a darkroom using a luminance colorimeter (product name: BM-5A, manufactured by TOPCON TECHNOHOUSE CORPORATION) with the input contrast ratio measurement signals defined by Rec. ITU-R BT 815-1. Note that the display was adjusted using PLUGE signals etc. and was in such a state that the luminance of the portion of Y level 940 (white 100%) was adjusted to 100 cd/m². In measurement, the function of adjusting the intensity (light amount) of the backlight did not work automatically or manually.

Comparing the antireflection film sheet of Comparative Example 3 with the antireflection film sheet of Comparative Example 2 which does not have a moth-eye structure, it can be seen that the moth-eye structure contributes to increasing the luminance in the white display state. This is because the transmittance of light emitted from the backlight improves. It can also be seen that the moth-eye structure contributes to decreasing the luminance in the black display state so that the black display quality can improve.

Comparing the antireflection film sheet of Comparative Example 3 with the antireflection film sheet of Comparative Example 4 which does not have an antiglare structure, it can be seen that the antiglare structure contributes to decreasing the luminance in the white display state and increasing the luminance in the black display state. As a result, due to the antiglare structure, the photopic contrast ratio decreases.

Now, compare the antireflection film sheet of Comparative Example 3 with the antireflection film sheet of Comparative Example 5 which can provide clear images. The luminance in the white display state and the luminance in the black display state are lower in the antireflection film sheet of Comparative Example 3 than in the antireflection film sheet of Comparative Example 5. The antireflection film sheet of Comparative Example 3 is better than the antireflection film sheet of Comparative Example 5 in respect of the photopic contrast ratio.

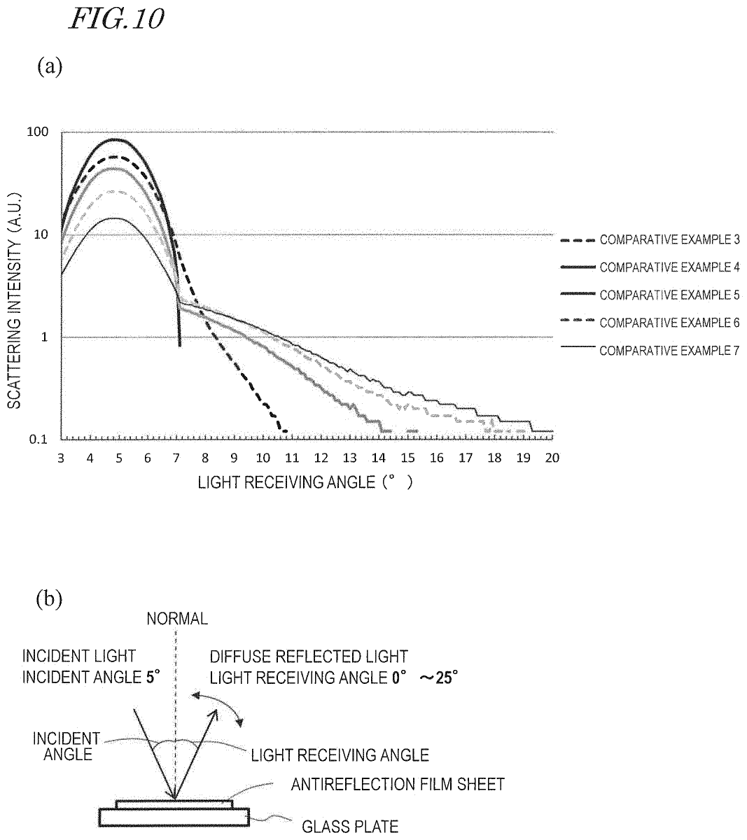

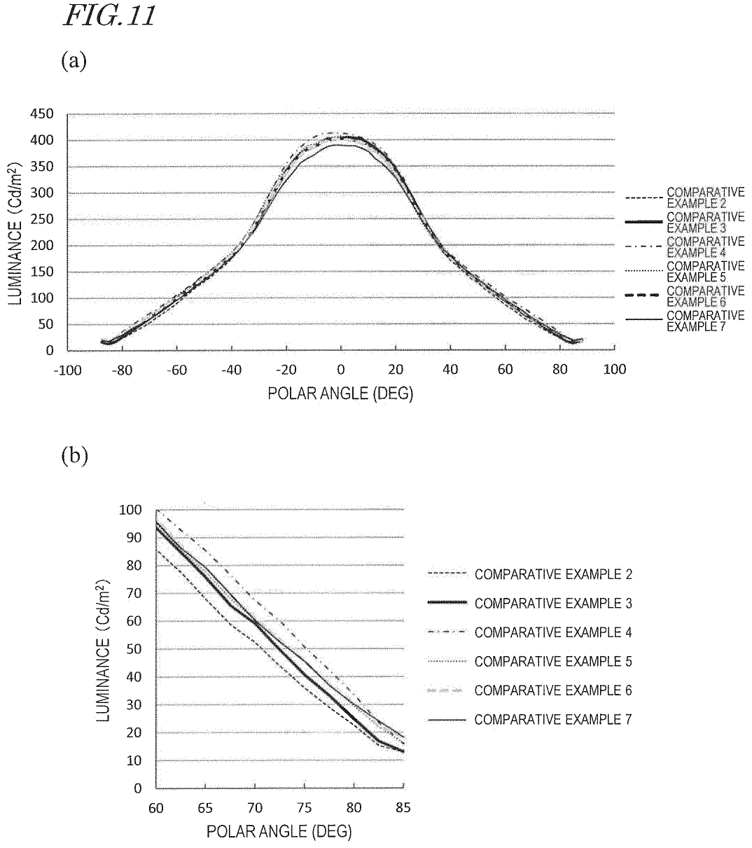

FIG. 10(a) is a graph showing the measurement results of the light distribution of diffuse reflected light from the antireflection film sheets of Comparative Example 3 to Comparative Example 7. FIG. 10(b) is a schematic diagram showing the system for measuring the light distribution of the diffuse reflected light. Note that the diffuse reflected light does not particularly exclude scattered light.

The light distribution of the diffuse reflected light was measured in such a manner that light was cast on the antireflection film sheet at an incident angle of 5° and the light receiving angle was 0° to 25° as shown in FIG. 10(b). Specifically, each antireflection film sheet was attached to a glass plate, and the light distribution was measured using a goniophotometer. The goniophotometer used was GP-200 manufactured by MURAKAMI COLOR RESEARCH LABORATORY. Here, the light distribution curves are shown where the incident angle is 5°, the horizontal axis represents the light receiving angle, and the vertical axis represents the common logarithm of the relative diffuse reflectance (%) which is normalized with the maximum of the diffuse reflected light intensity being 80%. This also applies to light distribution curves which will be described below unless otherwise stated.

The light distribution curves have a peak value at the light receiving angle of 5°. As will be described later with reference to FIG. 13, an antireflection film of an embodiment of the present invention is characterized in that, for example, the relative diffuse reflectance (%) is not less than 3% when the light receiving angle is in the range of not less than 5° and not more than 7°, the light distribution curve includes a point at which the light receiving angle is not less than 8° and not more than 10° and the relative diffuse reflectance (%) is in the range of not less than 2% and not more than 8%, and the light distribution curve includes a point at which the light receiving angle is not less than 10° and not more than 15° and the relative diffuse reflectance (%) is in the range of not less than 0.9% and not more than 1.1%. Details will be described later with reference to FIG. 13.

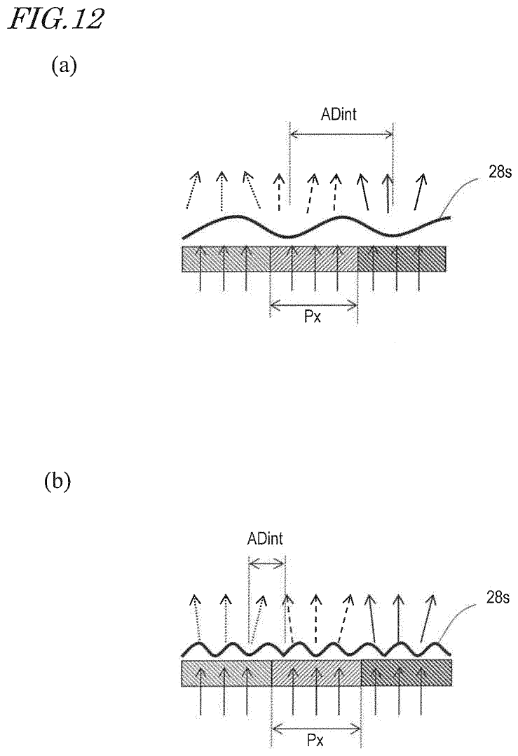

FIG. 11(a) and FIG. 11(b) are graphs showing the measurement results of the luminance in the white display state of the antireflection film sheets of Comparative Example 2 to Comparative Example 7, which was measured with varying polar angles. FIG. 11(b) shows an enlarged part of the graph of FIG. 11(a).

When the polar angle is large (for example, when the polar angle is not less than 50′^{p}), the antireflection film sheet of Comparative Example 2 which does not have a moth-eye structure has the lowest luminance among the antireflection film sheets of Comparative Example 2 to Comparative Example 7. That is, the luminances of the antireflection film sheets of Comparative Example 3 to Comparative Example 7 are higher than the luminance of the antireflection film sheet of Comparative Example 2 which does not have a moth-eye structure. For example, at the polar angle of 70°, the luminance of the antireflection film sheet of Comparative Example 4 which does not have an antiglare structure is higher by about 30% than the luminance of the antireflection film sheet of Comparative Example 2. For example, at the polar angle of 70°, the luminance of the antireflection film sheet of Comparative Example 3 is higher by about 15% than the luminance of the antireflection film sheet of Comparative Example 2. The reflectance at the surface of light incident at the display panel increases as the incident angle increases. Therefore, an antireflection film sheet which has a moth-eye structure at its surface has a large effect of reducing the surface reflection when viewed at an oblique viewing angle (particularly, large polar angle). The luminance of the antireflection film sheet of Comparative Example 3 is liable to be lower than the luminance of the antireflection film sheet of Comparative Example 4 which does not have an antiglare structure but generally equal to the luminances of the antireflection film sheets of Comparative Example 5 to Comparative Example 7 that are of the internal haze type.

Next, a production method of an antireflection film of an embodiment of the present invention and a production method of antireflection films of comparative examples are described.

As described in the foregoing, the present inventors studied a manufacturing method of a mold for production of an antireflection film which is capable of exhibiting an antiglare property while providing clear images and preventing itself from appearing whitish when viewed at an oblique viewing angle. As described in the foregoing, an antireflection film (or antireflection film) of an embodiment of the present invention has an antiglare structure at its surface and, therefore, a mold for production of such an antireflection film has an inverted antiglare structure at its surface. The present inventors studied various methods for forming an inverted antiglare structure at the surface of the mold and arrived at a mold manufacturing method of an embodiment of the present invention.

TABLE 4 shows the evaluation results as to the antireflection function and the antiglare function of the antireflection film sheet of Example 2 and the antireflection film sheets of Comparative Example 6 and Comparative Example 11 to Comparative Example 13.

TABLE 4

| | | | Comparative | Comparative | Comparative | Comparative |
|---|---|---|---|---|---|---|
| | | Example 2 | Example 11 | Example 12 | Example 13 | Example 6 |
| from | blurring of | ◯ | ◯ | ◯ | Δ | ◯ |
| front | reflected | | | | | |
| direction | image | | | | | |
| from | glare | ⊚ | X | ◯ | ◯ | Δ |
| front | | | | | | |
| direction | | | | | | |
| from | photopic | ◯ | ◯ | ◯ | ◯ | Δ |
| front | contrast | | | | | |
| direction | ratio | | | | | |
| from | luminance | ◯ | ◯ | ◯ | ◯ | ◯ |
| front | in white | | | | | |
| direction | display | | | | | |
| | state | | | | | |
| from | whitish | ◯ | ◯ | ◯ | ◯ | Δ |
| front | | | | | | |
| direction | | | | | | |
| at | whitish | ◯ | Δ | Δ | ◯ | Δ |
| oblique | | | | | | |
| viewing | | | | | | |
| angle | | | | | | |

The antireflection film sheets of Example 2 and Comparative Example 11 to Comparative Example 13 are external haze type antireflection film sheets which have the same configuration as that of the antireflection film sheet 50 shown in FIG. 8(a). As previously described, the evaluation results as to the antireflection function and the antiglare function of the external haze type antireflection film sheets can be considered to be equal to those as to the antireflection function and the antiglare function of the antireflection film of the antireflection film sheets.

The antireflection film of Example 2 was produced using a moth-eye mold manufactured by the above-described method. The conditions of the blasting treatment step in the process of manufacturing a moth-eye mold for production of the antireflection film of Example 2 are shown in TABLE 6.

The antireflection film of Comparative Example 11 was produced using a moth-eye mold manufactured as described below. The differences from a mold manufacturing method of an embodiment of the present invention are mainly described. The same applies to the subsequent paragraphs.

In the process of manufacturing a mold for production of the antireflection film of Comparative Example 11, the inorganic material layer 16 was formed by electrodeposition on the surface of the aluminum base 12 as disclosed in WO 2011/105206 and WO 2013/146656. The entire disclosures of WO 2011/105206 and WO 2013/146656 are incorporated by reference in this specification. A matting agent was mixed into the electrodeposition resin. When a matting agent is mixed into the electrodeposition resin, an inorganic material layer 16 which has an inverted antiglare structure at its surface can be formed. Herein, by mixing a matting agent into an acrylic melamine resin, a surface was formed which had, for example, raised portions whose two-dimensional size as viewed in the normal direction was about 20 μm and whose height was slightly smaller than 1 μm. When the inorganic material layer 16 is thus formed, the surface of the aluminum film 18 has a structure in which the inverted antiglare structure of the surface of the inorganic material layer 16 is reflected. The two-dimensional size of the raised portions that constitute the antiglare structure of the antireflection film of Comparative Example 11 was about 30 μm.

The electrodeposition may be, for example, a known electrodeposition coating method. For example, firstly, the base 12 is washed. Then, the base 12 is immersed in an electrodeposition bath in which an electrodeposition solution that contains an electrodeposition resin is stored. In the electrodeposition bath, an electrode is installed. When a curable resin layer is formed by means of cationic electrodeposition, an electric current is allowed to flow between the base 12 and the anode, where the base 12 serves as the cathode and the electrode installed in the electrodeposition bath serves as the anode, so that the electrodeposition resin is deposited on the outer perimeter surface of the base 12, whereby a curable resin layer is formed. When the curable resin layer is formed by means of anionic electrodeposition, an electric current is allowed to flow, where the base 12 serves as the anode and the electrode installed in the electrodeposition bath serves as the cathode, whereby the curable resin layer is formed. Thereafter, the washing step and the baking step are performed, whereby an organic insulating layer is formed. The electrodeposition resin used may be, for example, a polyimide resin, an epoxy resin, an acrylic resin, a melamine resin, a urethane resin, or a mixture thereof.

The antireflection film of Comparative Example 12 was produced using a moth-eye mold which was manufactured as follows. In the process of manufacturing a mold for production of the antireflection film of Comparative Example 12, a frosting treatment is performed on a mirror-finished surface of the aluminum base 12 using an aqueous solution containing the salt of hydrogen fluoride and ammonium as disclosed in WO 2015/159797, whereby an inverted antiglare structure was formed at the surface of the aluminum base 12. The entire disclosure of WO 2015/159797 is incorporated by reference in this specification. Herein, the aluminum base 12 used was made of an Al—Mg—Si based aluminum alloy, particularly JIS A6063.

Before the frosting treatment on the surface of the aluminum base 12, the step of etching the surface of the aluminum base 12 using an alkaline etchant (hereinafter, also referred to as “alkaline washing step”) was performed. By the alkaline washing step, at least part of a damaged layer of the aluminum base 12 which can be a cause of cutting scars can be removed. The alkaline washing step also serves as a degreasing step which is to be performed on the aluminum base 12. The alkaline washing step was performed at 40° C. for 40 minutes using an alkaline etchant. The alkaline etchant used was an aqueous solution prepared by adding an anticorrosion agent (CHELESBIT AL manufactured by CHELEST Corporation) as an acidic additive in the proportion of 10 vol % to an aqueous solution containing an organic alkaline detergent (manufactured by YOKOHAMA OILS & FATS INDUSTRY CO.LTD., product name: SEMICLEAN LC-2) in the concentration of 16 mass %.

After the alkaline washing step, a washing step with pure water, a pretreatment step, a frosting treatment step, an aftertreatment step, and another washing step with pure water were performed sequentially in this order.

In the frosting treatment step, the frosting treatment was performed at 10° C. for 3 minutes using an aqueous solution containing 2.5 mass % ammonium fluoride, 1 mass % ammonium sulfate and 1 mass % ammonium dihydrogen phosphate as the etchant for the frosting treatment. The frosting treatment step was carried out while the aluminum base 12 was rotated on the long axis (rotation speed: 5 rpm) and the etchant for the frosting treatment was circulated in the etching bath.

In the pretreatment step and the aftertreatment step, a surface treatment on the aluminum base 12 was carried out at room temperature for 3 minutes using a 2.5-fold dilution of the above-described etchant (specifically, an aqueous solution containing 1 mass % ammonium fluoride, 0.4 mass % ammonium sulfate and 0.4 mass % ammonium dihydrogen phosphate). The pretreatment step and the aftertreatment step were carried out while the aluminum base 12 was rotated on the long axis (rotation speed: 5 rpm). Herein, the etchant for the pretreatment and the etchant for the aftertreatment were not circulated in the etching bath. In the aftertreatment step, a bar-type shower unit was used together.

The washing step with pure water was carried out using a hand shower. In the washing step performed after the aftertreatment step, a dual fluid nozzle was used together.

The surface of the aluminum film 18 has a structure in which the inverted antiglare structure at the surface of the aluminum base 12 formed by the frosting treatment is reflected. The two-dimensional size of the raised portions that constitute the antiglare structure of the antireflection film of Comparative Example 12 was about 10 μm.

The antireflection film of Comparative Example 13 was produced using a moth-eye mold manufactured as described below. In the process of manufacturing a mold for production of the antireflection film of Comparative Example 13, the thickness of the aluminum film 18 was set to 1.0 μm, whereby an inverted antiglare structure was formed at the surface of the aluminum film 18. As disclosed in Patent Document No. 4, an aluminum film 18 is formed so as to have a thickness of not less than 0.5 μm and not more than 5 μm, whereby a moth-eye mold which has an inverted antiglare structure consisting of a plurality of raised portions whose average two-dimensional size is not less than 200 nm and not more than 5 μm can be manufactured.

In TABLE 4, “blurring of reflected image” and “whitish” were evaluated in the same way as previously described for TABLE 2 and TABLE 3. In TABLE 4, “photopic contrast ratio” and “luminance in white display state” were evaluated based on the results of measurement in the same way as previously described for FIG. 9 and FIG. 10. As for “photopic contrast ratio”, “0” means that the antireflection film has a sufficient contrast ratio, and “A” means that the contrast ratio is insufficient. As for “luminance in white display state”, “o” means that the antireflection film has a sufficient luminance. In TABLE 4, “glare” refers to the result of evaluation of the effect of suppressing occurrence of glare in an image viewed through an antireflection film adhered to a display panel. Details of the glare suppressing effect will be described later with reference to TABLE 5.

As seen from TABLE 4, the antireflection film of Example 2 is capable of exhibiting an antiglare property while providing clear images and preventing itself from appearing whitish when viewed at an oblique viewing angle.

If electrolytic polishing is performed on the surface of the aluminum base 12 after an inverted antiglare structure is formed at the surface of the aluminum base 12 by propelling an abrasive media toward the surface of the aluminum base 12, it can be further prevented from appearing whitish when viewed at an oblique viewing angle. It is estimated that, when electrolytic polishing is performed on the surface of the aluminum base 12, the inverted antiglare structure at the surface of the aluminum base 12 becomes moderate, so that it can be effectively prevented from appearing whitish when viewed at an oblique viewing angle.

The production cost of the antireflection film of Example 2 can be reduced by using a moth-eye mold manufactured by the above-described method. Specifically, the production cost is likely to become high when the mold is manufactured by a method which includes providing an antiglare film which has an antiglare function on the base 12 and then forming an aluminum film 18 on the antiglare film. According to a mold manufacturing method of an embodiment of the present invention, an abrasive media is propelled toward the surface of the base 12, and an aluminum film 18 is deposited on the base 12. Therefore, the production cost can be reduced.

The antireflection film of Comparative Example 11 appears whitish when viewed at an oblique viewing angle. Further, the antireflection film of Comparative Example 11 is not capable of sufficiently suppressing occurrence of glare.

The antireflection film of Comparative Example 12 appears whitish when viewed at an oblique viewing angle.

In the antireflection film of Comparative Example 13, blurring of a reflected image is not sufficient. That is, the antireflection film of Comparative Example 13 does not have a sufficient antiglare property.

The antireflection film sheet of Comparative Example 6 appears whitish when viewed at an oblique viewing angle. Further, the antireflection film sheet of Comparative Example 6 is not capable of sufficiently suppressing occurrence of glare. The antireflection film sheet of Comparative Example 6 is inferior to the antireflection film sheet of Example 2 in respect of the photopic contrast ratio as viewed from the front direction.

In TABLE 4, “glare” was evaluated as described below.

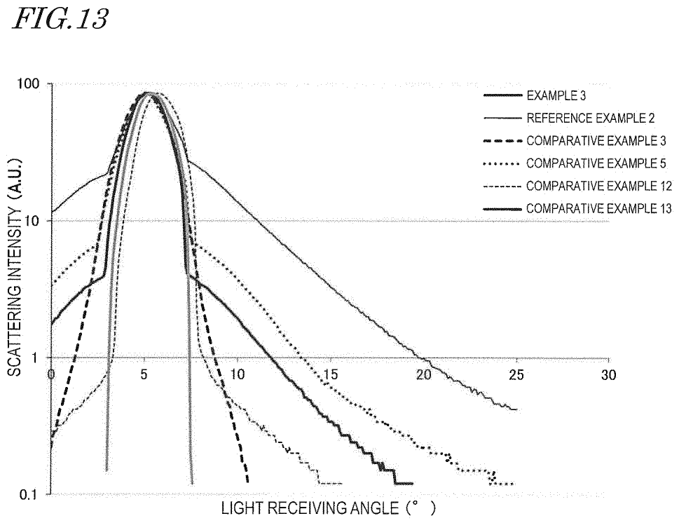

Occurrence of glare depends on the relationship in largeness between the uneven structure that forms the antiglare structure and the dot pitch Px in the row direction. Firstly, the relationship in largeness between the uneven structure that forms the antiglare structure and the dot pitch Px in the row direction is described with reference to FIG. 12.

FIG. 12(a) and FIG. 12(b) are diagrams schematically illustrating the relationship in largeness between the uneven structure that forms the antiglare structure and the dot pitch Px in the row direction. FIG. 12(a) shows a case where the uneven structure that forms the antiglare structure is larger than the dot pitch Px. FIG. 12(b) shows a case where the uneven structure that forms the antiglare structure is smaller than the dot pitch Px. Here, the dot refers to respective dots of R, G and B which form pixels in a typical color liquid crystal display panel. Specifically, when one of the pixels in the color liquid crystal display panel consists of three dots aligned in the row direction (R dot, G dot and B dot), the pixel pitch in the row direction is three times the dot pitch in the row direction, Px. Note that the pixel pitch in the column direction is equal to the dot pitch in the column direction, Py.

As schematically shown in FIGS. 12(a) and 12(b), a surface 28s which has the uneven structure that forms the antiglare structure can have a continuous wave-like surface shape which has no flat portion. The uneven structure that has such a continuous wave-like surface shape is characterized by the average of the distances between adjoining recessed portions (average adjoining distance ADᵢₙₜ) or the two-dimensional size of recessed portions, ADₚ. Although recessed portions are herein considered, the uneven structure can be characterized likewise even when raised portions are considered.

As shown in FIG. 12(a), when the average adjoining distance of recessed portions, ADᵢₙₜ (which is assumed to be equal to the two-dimensional size of recessed portions, ADₚ) is for example greater than the row direction dot pitch Px (the pixel pitch in the row direction is three times the dot pitch when one pixel consists of three dots (R, G, B)), a sufficient antiglare function cannot be achieved. To sufficiently achieve the antiglare function, it is preferred that, as shown in FIG. 12(b), the average adjoining distance ADᵢₙₜ of recessed portions (the two-dimensional size ADₚ of recessed portions) is mutually approximately equal and is smaller than the dot pitch.

TABLE 5 shows the results of evaluation by eye observation as to whether or not glaring of the display surface occurred with the antireflection film sheets of Example 2, Comparative Example 5 and Comparative Example 11 being adhered to the viewer side surface of four types of display panels which had different dot pitches. In TABLE 5, “x” means that there was glaring in both full-screen green displaying and full-screen white displaying, “Δ” means that glaring was inconspicuous in full-screen white displaying but there was glaring in full-screen green displaying, “0” means that glaring was inconspicuous in full-screen white displaying but there was slight glaring in full-screen green displaying, and “⊚” means that there was not glaring at all. In TABLE 4, the section of “glare” shows the results of evaluation using one of the displays of TABLE 5, with 9.7 inches on diagonal, the dot pitch in the row direction (Px in FIG. 12) being about 32 μm, the dot pitch in the column direction (equal to pixel pitch) being about 96 μm, and about 264 ppi. Although not shown in TABLE 5, the evaluation of Comparative Example 6 was carried out in the same way.

TABLE 5

| | dot pitch | | | | |
|---|---|---|---|---|---|
| | (row direction × | | | Comparative | Comparative |
| type of display | column direction) | resolution | Example 2 | Example 5 | Example 11 |
| 4.97 inches FHD | 19 μm × 57 μm | 443 ppi | ◯ | X | X |
| (for smartphones) | | | | | |
| 9.7 inches 2048 × 1536 | 32 μm × 96 μm | 264 ppi | ⊚ | Δ | X |
| (for tablet computers) | | | | | |
| 32 inches 4K2K | 62 μm × 186 μm | 138 ppi | ⊚ | ◯ | X |
| (for TV, high- | | | | | |
| definition model) | | | | | |
| 32 inches FHD | 123 μm × 369 μm | 69 ppi | ⊚ | ⊚ | ◯ |
| (for TV, existing | | | | | |
| model) | | | | | |

The two-dimensional size ADₚ of the first raised portions that form the antiglare structure at the surface of the antireflection film of Example 2 is not more than 5 μm. From the viewpoint of suppressing occurrence of glare, it is preferred that the two-dimensional size ADₚ of the first raised portions is sufficiently smaller than the dot pitch in the row direction.

The two-dimensional size of the raised portions that form the antiglare structure of the antireflection film of Comparative Example 11 is about 30 μm. The two-dimensional size of the raised portions that form the antiglare structure of the antireflection film of Comparative Example 11 is greater than the two-dimensional size of the raised portions that form the antiglare structure of the antireflection film of Example 2. Therefore, in respect of suppressing occurrence of glare, the antireflection film of Comparative Example 11 is inferior to the antireflection film of Example 2.

The antireflection film sheet of Comparative Example 5 is of the internal haze type and therefore does not have an antiglare structure at its surface. The antireflection film sheet of Example 2 is better than the antireflection film sheet of Comparative Example 5 in respect of suppressing occurrence of glare.

FIG. 13 is a graph showing the measurement results of the light distribution of diffuse reflected light from the antireflection film sheets of Example 3, Reference Example 2, Comparative Example 3, Comparative Example 5, Comparative Example 12 and Comparative Example 13. Also in FIG. 13, likewise as in FIG. 10(a), the light distribution curves are shown where the incident angle is 5°, the horizontal axis represents the light receiving angle, and the vertical axis represents the common logarithm of the relative diffuse reflectance (%) which is normalized with the maximum of the diffuse reflected light intensity being 80%.

The antireflection film sheets of Example 3 and Reference Example 2 are external haze type antireflection film sheets which have the same configuration as that of the antireflection film sheet 50 shown in FIG. 8(a). The antireflection films of Example 3 and Reference Example 2 were produced by the above-described method. The conditions of the blasting treatment step in the process of manufacturing moth-eye molds for production of the antireflection films of Example 3 and Reference Example 2 are shown in TABLE 6.

The light distribution curve of the antireflection film sheet of Example 3 has a peak value at the light receiving angle of 5°. The peak width is relatively narrow. The gradient moderately inflects in the light receiving angle range of 2° to 3° and in the light receiving angle range of 7° to 8°. The light distribution curve lies inside the light receiving angle of 20°. The antireflection film sheet of Example 3 is capable of exhibiting an antiglare property while providing clear images and preventing itself from appearing whitish when viewed at an oblique viewing angle. The light distribution curve of the antireflection film sheet of Reference Example 2 does not lie inside the light receiving angle of 25°. The antireflection film sheet of Reference Example 2 is liable to appear whitish when viewed at an oblique viewing angle.

An antireflection film of an embodiment of the present invention is characterized in that, for example, the relative diffuse reflectance (%) is not less than 3% when the light receiving angle is in the range of not less than 5° and not more than 7°, the light distribution curve includes a point at which the light receiving angle is not less than 8° and not more than 10° and the relative diffuse reflectance (%) is in the range of not less than 2% and not more than 8%, and the light distribution curve includes a point at which the light receiving angle is not less than 10° and not more than 15° and the relative diffuse reflectance (%) is in the range of not less than 0.9% and not more than 1.1%.

According to research conducted by the present inventors, there is a tendency as follows. From the viewpoint of exhibiting an antiglare property while providing clear images and preventing itself from appearing whitish when viewed at an oblique viewing angle, it is preferred that the peak width is relatively narrow and the light distribution curve does not include a point at which the gradient of the light distribution curve discontinuously varies. Also, it is preferred that, outside the peak, the light distribution curve rapidly attenuates as it goes away from the peak center (5°).

TABLE 6 shows the conditions of the blasting treatment step for the experimental examples in the specification (the conditions for propelling of the abrasive media and the type of the abrasive media) and the type of aluminum on which the blasting treatment was performed. Specifically, TABLE 6 shows the type of aluminum for formation of the aluminum base 12, the type of the abrasive media, the average particle diameter of the abrasive media, the pressure for propelling the abrasive media from the nozzle 82, the distance d between the nozzle 82 and the surface of the mold base 10, and the velocity vᵥ of movement of the nozzle 82 in the long axis direction of the mold base 10.

TABLE 6

| | | | average | | | |
|---|---|---|---|---|---|---|
| | | | particle | | | |
| | | | diameter | | | nozzle |
| | | | of | | | moving |
| | | | abrasive | ejection | distance | velocity |
| Experimental | aluminum | abrasive | media | pressure | d | vᵥ |
| Examples | base 12 | media | [μm] | [MPa] | [mm] | [mm/s] |
| FIG. 4(a) | A6063 | alumina | 17 | 0.1 | 200 | 200 |
| FIG. 4(b) | A6063 | alumina | 17 | 0.1 | 200 | 452 |
| antiglare | A6063 | alumina | 17 | 0.1 | 200 | 370 |
| film No.1 | | | | | | |
| antiglare | A6063 | alumina | 17 | 0.08 | 200 | 370 |
| film No.2 | | | | | | |
| antiglare | A6063 | alumina | 17 | 0.1 | 150 | 370 |
| film No.3 | | | | | | |
| antiglare | A6063 | glass | 23 | 0.1 | 200 | 370 |
| film No.4 | | beads | | | | |
| Example 1 | A6063 | alumina | 17 | 0.08 | 200 | 370 |
| Reference | A6063 | alumina | 17 | 0.1 | 150 | 370 |
| Example 1 | | | | | | |
| Example 2 | A6063 | alumina | 17 | 0.1 | 200 | 370 |
| Example 3 | A6063 | alumina | 17 | 0.1 | 200 | 370 |
| Reference | A6063 | alumina | 17 | 0.1 | 200 | 370 |
| Example 2 | | | | | | |

### INDUSTRIAL APPLICABILITY

An embodiment of the present invention is suitably used for, for example, an antireflection film for use in high-definition display panels, a method for producing such an antireflection film, a mold for producing such an antireflection film, and a method for efficiently manufacturing such a mold.

### REFERENCE SIGNS LIST

10 mold base
12 base (aluminum base)
12a first recessed portion
14 porous alumina layer
14p second recessed portion
16 inorganic material layer
18 aluminum film
18s surface
18a third recessed portion
32 antireflection film
100 moth-eye mold

1: A mold manufacturing method comprising the steps of:
(a) providing a mechanically mirror-finished aluminum base;
(b) propelling an abrasive media toward a surface of the aluminum base, thereby forming a plurality of first recessed portions at the surface of the aluminum base, the abrasive media being generally-spherical, the abrasive media containing an alumina particle, an average particle diameter of the abrasive media being not less than 10 μm and not more than 40 μm;
(c) after step (b), forming an inorganic material layer over the surface of the aluminum base and forming an aluminum film over the inorganic material layer, thereby forming a mold base;
(d) after step (c), anodizing a surface of the aluminum film, thereby forming a porous alumina layer which has a plurality of second recessed portions;
(e) after step (d), bringing the porous alumina layer into contact with an etchant, thereby enlarging the plurality of second recessed portions of the porous alumina layer; and
(f) after step (e), further performing anodization, thereby growing the plurality of second recessed portions.

2: The method of claim 1, wherein the average particle diameter of the abrasive media is not less than 10 μm and less than 35 μm.

3: The method of claim 1, wherein a granularity distribution of the abrasive media has a peak within a range of ±10% from the average particle diameter.

4: The method of claim 1 further comprising the step of
(g) between step (b) and step (c), performing electrolytic polishing on the surface of the aluminum base.

5: A mold manufactured by the mold manufacturing method as set forth in claim 1.

6: A mold comprising a surface structure, the surface structure having a plurality of first recessed portions whose two-dimensional size as viewed in a normal direction of the surface is not less than 1 μm and not more than 12 μm and a plurality of second recessed portions whose two-dimensional size as viewed in a normal direction of the surface is not less than 10 nm and less than 500 nm,
wherein an adjoining distance of the plurality of first recessed portions is not less than 2 μm and not more than 10 μm.

7: An antireflection film production method, comprising the steps of:
providing the mold as set forth in claim 5;
providing a work;
irradiating a photocurable resin applied between the mold and a surface of the work with light, thereby curing the photocurable resin; and
separating the mold from an antireflection film that is formed of the cured photocurable resin.

8: An antireflection film produced by the antireflection film production method as set forth in claim 7.

9: An antireflection film comprising a surface structure, the surface structure having a plurality of first raised portions whose two-dimensional size as viewed in a normal direction of the surface is not less than 1 μm and not more than 12 μm and a plurality of second raised portions whose two-dimensional size as viewed in a normal direction of the surface is not less than 10 nm and less than 500 nm,
wherein a specular gloss at 20° is not less than 0.01 and not more than 0.1 when a specular gloss at 60° is assumed to be 1.

10: The antireflection film of claim 8, wherein the specular gloss at 20° is not less than 0.01 and not more than 1.0, and the specular gloss at 60° is not less than 1.0 and not more than 10.0.

11: The antireflection film of claim 8, wherein the specular gloss at 20° is not less than 0.001 and not more than 0.005 when a specular gloss at 85° is assumed to be 1.

12: The antireflection film of claim 8, wherein the specular gloss at 85° is not less than 50.0 and not more than 75.0.

13: The antireflection film of claim 8, wherein a light distribution curve for an incident angle of 5° in a graph where a horizontal axis represents a light receiving angle and a vertical axis represents a common logarithm of a relative diffuse reflectance (%) which is normalized with a maximum of a diffuse reflected light intensity being 80% is characterized in that
the relative diffuse reflectance (%) is not less than 3% when the light receiving angle is in a range of not less than 5° and not more than 7°,
the light distribution curve includes a point at which the light receiving angle is in a range of not less than 8° and not more than 10° and the relative diffuse reflectance (%) is in a range of not less than 2% and not more than 8%, and
the light distribution curve includes a point at which the light receiving angle is in a range of not less than 10° and not more than 15° and the relative diffuse reflectance (%) is in a range of not less than 0.9% and not more than 1.1%.

14: The antireflection film of claim 8, wherein a haze value is not less than 2% and not more than 40%.

15-16. (canceled)
